(19) United States
(12) Patent Application Publication
(10) Pub. No.: US 2026/0262118 A1
(43) Pub. Date: Sep. 3, 2026

(54) REPORTING PRECODING MATRIX INFORMATION FOR MULTIPLE CANDIDATE TRANSMISSION AND RECEPTION POINT GROUPS

(71) Applicant: QUALCOMM INCORPORATED, San Diego, CA (US)

(72) Inventors: Min Huang, Beijing (CN); Jing Dai, Beijing (CN); Chao Wei, Beijing (CN)

(21) Appl. No.: 18/846,623

(22) PCT Filed: May 13, 2022
(86) PCT No.: PCT/CN2022/092639

§ 371 Date: Sep. 12, 2024

(51) Int. Cl. H04W 76/15; H04B 7/0456

(52) U.S. Cl. CPC H04W 76/15; H04B 7/0456

(57) ABSTRACT

Methods, systems, and devices for wireless communications are described. The method may include a user equipment (UE) receiving an indication of a set of transmission-reception point (TRP) groups from a network entity. Upon receiving the indication, the UE may transmit, to the network entity and for each TRP that is included in the set of TRP groups, an indication of one or more respective single-TRP precoding matrix components and transmit, to the network entity and for each TRP group that is included in the set of TRP groups, an indication of one or more respective multi-TRP precoding matrix components. Using a combination of the one or more respective multi-TRP precoding matrix components and the one or more respective single-TRP precoding matrix components, the network entity may determine a precoding matrix for communication with the UE.

### CROSS REFERENCE

The present Application is a 371 national stage filing of International PCT Application No. PCT/CN2022/092639 by Huang et al. entitled “REPORTING PRECODING MATRIX INFORMATION FOR MULTIPLE CANDIDATE TRANSMISSION AND RECEPTION POINT GROUPS,” filed May 13, 2022, which is assigned to the assignee hereof, and which is expressly incorporated by reference in its entirety herein.

### FIELD OF TECHNOLOGY

The following relates to wireless communications, including reporting precoding matrix information for multiple candidate transmission-reception point (TRP) groups

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a network entity (e.g., a base station) may communicate with UE using one or more transmission-reception points (TRPs). Further, the UE and the network entity may implement joint transmission (JT). JT may allow the UE to receive signaling from two or more TRPs using the same frequency and time resources.

### SUMMARY

The described techniques relate to improved methods, systems, devices, and apparatuses that support reporting precoding matrix information for multiple candidate transmission-reception point (TRP) groups. For example, the described techniques provide for a user equipment (UE) to report partial precoding matrix information to a network entity for the purpose of coherent joint transmission (CJT). In some examples, the UE may receive a control message from the network entity indicating a set of TRP groups, where each TRP group of the set of TRP groups includes at least two or more TRPs. Upon receiving the control message, the UE may transmit an indication of one or more first precoding matrix components for each TRP included in the set of TRP groups. In some examples, the one or more first precoding components may include one or more respective spatial domain basis matrices and one or more respective frequency domain matrices. Additionally, the UE may transmit an indication of one or more second precoding matrix components for each TRP group of the set of TRP groups. In some examples, the one or more second precoding matrix components may include one or more respective spatial-frequency coefficient matrices or one or more scalar coefficients. The network entity may then communicate with the UE via a TRP group of the set of TRP groups using a precoding matrix that is determined based on the one or more first precoding components for each TRP in the TRP group and the one or more second precoding matrix components for the TRP group.

A method for wireless communication at a UE is described. The method may include receiving an indication of a set of multiple TRP groups that include two or more TRPs, where the set of multiple TRP groups are candidate TRP groups for communicating with the UE via JT, transmitting, for each TRP that is included in one or more of the multiple TRP groups, an indication of one or more respective single-TRP precoding matrix components, and transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

An apparatus for wireless communication at a UE is described. The apparatus may include a memory, a transceiver, and at least one processor of the UE, the at least one processor coupled with the memory and the transceiver. The at least one processor may be configured to receive an indication of a set of multiple TRP groups that include two or more TRPs, where the set of multiple TRP groups are candidate TRP groups for communicating with the UE via JT, transmit, for each TRP that is included in one or more of the multiple TRP groups, an indication of one or more respective single-TRP precoding matrix components, and transmit, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

Another apparatus for wireless communication at a UE is described. The apparatus may include means for receiving an indication of a set of multiple TRP groups that include two or more TRPs, where the set of multiple TRP groups are candidate TRP groups for communicating with the UE via JT, means for transmitting, for each TRP that is included in one or more of the multiple TRP groups, an indication of one or more respective single-TRP precoding matrix components, and means for transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

A non-transitory computer-readable medium storing code for wireless communication at a UE is described. The code may include instructions executable by a processor to receive an indication of a set of multiple TRP groups that include two or more TRPs, where the set of multiple TRP groups are candidate TRP groups for communicating with the UE via JT, transmit, for each TRP that is included in one or more of the multiple TRP groups, an indication of one or more respective single-TRP precoding matrix components, and transmit, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

In some examples of the method, apparatuses, and non-transitory computer-readable medium described herein, transmitting the indication of the one or more respective single-TRP precoding matrix components may include operations, features, means, or instructions for transmitting, for each TRP that may be included in one or more of the multiple TRP groups, an indication of one or more respective spatial domain basis matrices, one or more respective frequency domain basis matrices, or any combination thereof.

In some examples of the method, apparatuses, and non-transitory computer-readable medium described herein, transmitting the indication of the one or more respective multi-TRP precoding matrix components may include operations, features, means, or instructions for transmitting, for each TRP group that may be included in the set of multiple TRP groups, an indication of one or more respective spatial-frequency coefficient matrices.

In some examples of the method, apparatuses, and non-transitory computer-readable medium described herein, transmitting the indication of the one or more respective single-TRP precoding matrix components may include operations, features, means, or instructions for transmitting, for each TRP that may be included in one or more of the multiple TRP groups, an indication of one or more respective spatial-frequency coefficient matrices.

In some examples of the method, apparatuses, and non-transitory computer-readable medium described herein, transmitting the indication of the one or more respective multi-TRP precoding matrix components may include operations, features, means, or instructions for transmitting, for each TRP group that may be included in the set of multiple TRP groups, an indication of one or more respective scalar coefficients.

In some examples of the method, apparatuses, and non-transitory computer-readable medium described herein, each of the one or more respective scalar coefficients includes a respective amplitude and a respective phase and the method, apparatuses, and non-transitory computer-readable medium may include further operations, features, means, or instructions for receiving a control message indicating a first quantity of bits for encoding each of the respective amplitudes and a second quantity of bits for encoding each of the respective phases, where the indication of the one or more scalar coefficients may be based on the encoding each of the respective amplitudes using the first quantity of bits and encoding each of the respective phases using the second quantity of bits.

In some examples of the method, apparatuses, and non-transitory computer-readable medium described herein, for each TRP that may be included in one or more of the multiple TRP groups, the one or more single-TRP precoding matrix components include at least one single-TRP precoding matrix component for each single-TRP spatial layer of each TRP.

In some examples of the method, apparatuses, and non-transitory computer-readable medium described herein, the set of multiple TRP groups includes a first TRP group and the method, apparatuses, and non-transitory computer-readable medium may include further operations, features, means, or instructions for selecting a respective single-TRP spatial layer from each TRP that may be included in the first TRP group, the selected single-TRP spatial layers corresponding to a first multi-TRP spatial layer of the first TRP group and determining the one or more respective multi-TRP precoding matrix components for the first TRP group based on the selected single-TRP spatial layers.

Some examples of the method, apparatuses, and non-transitory computer-readable medium described herein may further include operations, features, means, or instructions for transmitting an indication of the selected single-TRP spatial layers corresponding to the first multi-TRP spatial layer of the first TRP group.

Some examples of the method, apparatuses, and non-transitory computer-readable medium described herein may further include operations, features, means, or instructions for receiving a control message that indicates a procedure for reporting precoding matrix information, the indicated procedure included in a set of two or more candidate procedures for reporting the precoding matrix information that includes a first procedure and a second procedure and performing the indicated procedure for reporting the precoding matrix information, where the first procedure includes transmitting, for each TRP group that may be included in the set of multiple TRP groups, an indication of one or more respective spatial-frequency coefficient matrices, and the second procedure includes transmitting, for each TRP group that may be included in the set of multiple TRP groups, an indication of one or more respective scalar coefficients. Responsive to the first procedure being indicated, transmitting the indication of the one or more respective multi-TRP precoding matrix components for each TRP group included in the plurality of TRP groups includes transmitting an indication of one or more respective spatial-frequency coefficient matrices for each TRP group included in the plurality of TRP groups. Responsive to the second procedure being indicated, transmitting the indication of the one or more respective multi-TRP precoding matrix components for each TRP group included in the plurality of TRP groups comprises transmitting an indication of one or more respective scalar coefficients for each TRP group included in the plurality of TRP groups.

Some examples of the method, apparatuses, and non-transitory computer-readable medium described herein may further include operations, features, means, or instructions for communicating with the TRP group via JT based on the precoding matrix.

In some examples of the method, apparatuses, and non-transitory computer-readable medium described herein, the indication of the set of multiple TRP groups may be received as part of a channel state information (CSI) reporting configuration message and the indications of the one or more respective single-TRP precoding matrix components and the indications of the one or more respective multi-TRP precoding matrix components may be transmitted as part of a CSI report.

A method for wireless communication at a network entity is described. The method may include transmitting an indication of a set of multiple TRP groups that include two or more TRPs, where the set of multiple TRP groups are candidate TRP groups for communicating with a UE via JT, receiving, for each TRP that is included in one or more of the multiple TRP groups, an indication of one or more respective single-TRP precoding matrix components, receiving, for each TRP group that is included in the set of multiple TRP groups, an indication of one or more respective multi-TRP precoding matrix components, and determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

An apparatus for wireless communication at a network entity is described. The apparatus may include a memory and at least one processor of the network entity, the at least one processor coupled with the memory. The at least one processor may be configured to transmit an indication of a set of multiple TRP groups that include two or more TRPs, where the set of multiple TRP groups are candidate TRP groups for communicating with a UE via JT, receive, for each TRP that is included in one or more of the multiple TRP groups, an indication of one or more respective single-TRP precoding matrix components, receive, for each TRP group that is included in the set of multiple TRP groups, an indication of one or more respective multi-TRP precoding matrix components, and determine a precoding matrix for a TRP group of the set of multiple TRP groups based on a combination of the one or more respective multi-TRP precoding matrix components for the TRP group and the one or more respective single-TRP precoding matrix components for each TRP included in the TRP group.

Another apparatus for wireless communication at a network entity is described. The apparatus may include means for transmitting an indication of a set of multiple TRP groups that include two or more TRPs, where the set of multiple TRP groups are candidate TRP groups for communicating with a UE via JT, means for receiving, for each TRP that is included in one or more of the multiple TRP groups, an indication of one or more respective single-TRP precoding matrix components, means for receiving, for each TRP group that is included in the set of multiple TRP groups, an indication of one or more respective multi-TRP precoding matrix components, and means for determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

A non-transitory computer-readable medium storing code for wireless communication at a network entity is described. The code may include instructions executable by a processor to transmit an indication of a set of multiple TRP groups that include two or more TRPs, where the set of multiple TRP groups are candidate TRP groups for communicating with a UE via JT, receive, for each TRP that is included in one or more of the multiple TRP groups, an indication of one or more respective single-TRP precoding matrix components, receive, for each TRP group that is included in the set of multiple TRP groups, an indication of one or more respective multi-TRP precoding matrix components, and determine a precoding matrix for a TRP group of the set of multiple TRP groups based on a combination of the one or more respective multi-TRP precoding matrix components for the TRP group and the one or more respective single-TRP precoding matrix components for each TRP included in the TRP group.

In some examples of the method, apparatuses, and non-transitory computer-readable medium described herein, receiving the indication of the one or more respective single-TRP precoding matrix components may include operations, features, means, or instructions for receiving, for each TRP that may be included in one or more of the multiple TRP groups, an indication of one or more respective spatial domain basis matrices, one or more respective frequency domain basis matrices, or any combination thereof.

In some examples of the method, apparatuses, and non-transitory computer-readable medium described herein, receiving the indication of the one or more respective multi-TRP precoding matrix components may include operations, features, means, or instructions for receiving, for each TRP group that may be included in the set of multiple TRP groups, an indication of one or more respective spatial-frequency coefficient matrices.

In some examples of the method, apparatuses, and non-transitory computer-readable medium described herein, receiving the indication of the one or more respective single-TRP precoding matrix components may include operations, features, means, or instructions for receiving, for each TRP that may be included in one or more of the multiple TRP groups, an indication of one or more respective spatial-frequency coefficient matrices.

In some examples of the method, apparatuses, and non-transitory computer-readable medium described herein, receiving the indication of the one or more respective multi-TRP precoding matrix components may include operations, features, means, or instructions for receiving, for each TRP group that may be included in the set of multiple TRP groups, an indication of one or more respective scalar coefficients.

In some examples of the method, apparatuses, and non-transitory computer-readable medium described herein, each of the one or more respective scalar coefficients includes a respective amplitude and a respective phase and the method, apparatuses, and non-transitory computer-readable medium may include further operations, features, means, or instructions for transmitting a control message indicating a first quantity of bits for encoding each of the respective amplitudes and a second quantity of bits for encoding each of the respective phases, where the indication of the one or more scalar coefficients may be based on the each of the respective amplitudes being encoded using the first quantity of bits and each of the respective phases being encoded using the second quantity of bits.

In some examples of the method, apparatuses, and non-transitory computer-readable medium described herein, for each TRP that may be included in one or more of the multiple TRP groups, the one or more single-TRP precoding matrix components include at least one single-TRP precoding matrix component for each single-TRP spatial layer of each TRP.

In some examples of the method, apparatuses, and non-transitory computer-readable medium described herein, the set of multiple TRP groups includes a first TRP group and the method, apparatuses, and non-transitory computer-readable medium may include further operations, features, means, or instructions for receiving an indication of selected single-TRP spatial layers corresponding to a first multi-TRP spatial layer of the first TRP group, where the selected single-TRP spatial layers include a respective single-TRP spatial layer from each TRP that may be included in the first TRP group and the one or more respective multi-TRP precoding matrix components for the first TRP group may be based on the selected single-TRP spatial layers.

Some examples of the method, apparatuses, and non-transitory computer-readable medium described herein may further include operations, features, means, or instructions for transmitting a control message that indicates a procedure for reporting precoding matrix information, the indicated procedure included in a set of two or more candidate procedures for reporting the precoding matrix information that includes a first procedure and a second procedure, where the first procedure includes the UE transmitting (and the network entity receiving), for each TRP group that may be included in the set of multiple TRP groups, an indication of one or more respective spatial-frequency coefficient matrices, the second procedure includes the UE transmitting (and the network entity receiving), for each TRP group that may be included in the set of multiple TRP groups, an indication of one or more respective scalar coefficients, and the indications of the one or more respective single-TRP precoding matrix components and the indications of the one or more respective multi-TRP precoding matrix components may be in accordance with the indicated procedure for reporting the precoding matrix information. Responsive to the first procedure being indicated, receiving the indication of the one or more respective multi-TRP precoding matrix components for each TRP group included in the plurality of TRP groups includes receiving an indication of one or more respective spatial-frequency coefficient matrices for each TRP group included in the plurality of TRP groups. Responsive to the second procedure being indicated, receiving the indication of the one or more respective multi-TRP precoding matrix components for each TRP group included in the plurality of TRP groups includes receiving an indication of one or more respective scalar coefficients for each TRP group included in the plurality of TRP groups.

Some examples of the method, apparatuses, and non-transitory computer-readable medium described herein may further include operations, features, means, or instructions for communicating with the UE via the TRP group and JT based on the precoding matrix.

In some examples of the method, apparatuses, and non-transitory computer-readable medium described herein, the indication of the plurality TRP groups may be transmitted as part of a CSI reporting configuration message and the indications of the one or more respective single-TRP precoding matrix components and the indications of the one or more respective multi-TRP precoding matrix components may be received as part of a CSI report.

### BRIEF DESCRIPTION OF THE DRAWINGS

FIGS. 1 and 2 illustrate examples of a wireless communications system that supports reporting precoding matrix information for multiple candidate transmission-reception point (TRP) groups in accordance with one or more aspects of the present disclosure.

FIG. 3 illustrates an example of a precoding matrix indicator (PMI) reporting scheme that supports reporting precoding matrix information for multiple candidate TRP groups in accordance with one or more aspects of the present disclosure.

FIG. 4 illustrates an example of a process flow that supports reporting precoding matrix information for multiple candidate TRP groups in accordance with one or more aspects of the present disclosure.

FIGS. 5 and 6 show block diagrams of devices that support reporting precoding matrix information for multiple candidate TRP groups in accordance with one or more aspects of the present disclosure.

FIG. 7 shows a block diagram of a communications manager that supports reporting precoding matrix information for multiple candidate TRP groups in accordance with one or more aspects of the present disclosure.

FIG. 8 shows a diagram of a system including a device that supports reporting precoding matrix information for multiple candidate TRP groups in accordance with one or more aspects of the present disclosure.

FIGS. 9 and 10 show block diagrams of devices that support reporting precoding matrix information for multiple candidate TRP groups in accordance with one or more aspects of the present disclosure.

FIG. 11 shows a block diagram of a communications manager that supports reporting precoding matrix information for multiple candidate TRP groups in accordance with one or more aspects of the present disclosure.

FIG. 12 shows a diagram of a system including a device that supports reporting precoding matrix information for multiple candidate TRP groups in accordance with one or more aspects of the present disclosure.

FIGS. 13 through 16 show flowcharts illustrating methods that support reporting precoding matrix information for multiple candidate TRP groups in accordance with one or more aspects of the present disclosure.

### DETAILED DESCRIPTION

In some examples, a user equipment (UE) may communicate with a network entity (e.g., a base station) using one or more transmission-reception points (TRPs). Moreover, the UE may support coherent joint transmission (CJT). During CJT, the UE may receive signaling from two or more TRPs (e.g., a TRP group) concurrently (e.g., over the same time and frequency resources). To enable CJT, the UE may report precoding matrix information (e.g., a spatial domain basis matrix, a frequency domain basis matrix, and a spatial-frequency coefficient matrix) for the corresponding TRP group. However, the network entity may be unaware when configuring the UE for precoding matrix information reporting of which TRPs that it later will schedule to communicate with the UE via CJT. As such, the network entity may instruct the UE to report full precoding matrix information for multiple possible combinations of TRPs for which CJT is possible. The possible combinations of TRPs may be referred to as candidate TRP groups or multi-TRP hypotheses. But reporting full precoding matrix information for each of the possible candidate TRP group may undesirably increase overhead signaling and decrease the efficiency of the wireless communications system.

As described herein, a UE may report partial precoding matrix information for each of the individual TRPs that are included in one or more of the candidate TRP groups and other partial precoding matrix information for each of the candidate TRP groups. In some examples, the network entity may transmit signaling indicating multiple candidate TRP groups including two or more TRPs. Upon receiving the signaling, the UE may receive reference signals (e.g., channel state information (CSI) reference signals (CSI-RS)) from each of the TRPs included in the indicated candidate TRP groups and perform measurements based on the received reference signals. Using the measurements, the UE may determine and report a spatial domain basis matrix and a frequency domain basis matrix for each TRP of the candidate TRP groups and for each layer. Moreover, using the measurements, the UE may determine and report a spatial-frequency coefficient matrix for each TRP group of the candidate TRP groups and for a selected layer.

Alternatively, using the measurements, the UE may determine and report a spatial domain basis matrix, a frequency domain basis matrix, and a spatial-frequency coefficient matrix for each TRP of the candidate TRP groups and for each layer. Moreover, using the measurements, the UE may determine and report a complex scalar coefficient for each TRP group of the multiple TRP groups and for a selected layer of each TRP of the TRP groups. Using a combination of the reported partial precoding matrix information, the network entity may determine a precoding matrix for which to communicate with the UE via a TRP group of the candidate TRP groups. The techniques may allow the network entity to share the partial precoding matrix information for each individual TRP among different TRP groups. As such, the partial precoding matrix information may be reported once which may result in less signaling overhead when compared to reporting full precoding matrix information for each TRP group.

Aspects of the disclosure are initially described in the context of wireless communications systems. Additional aspects are described in the context of a PMI reporting scheme and a process flow. Aspects of the disclosure are further illustrated by and described with reference to apparatus diagrams, system diagrams, and flowcharts that relate to reporting precoding matrix information for multiple candidate TRP groups.

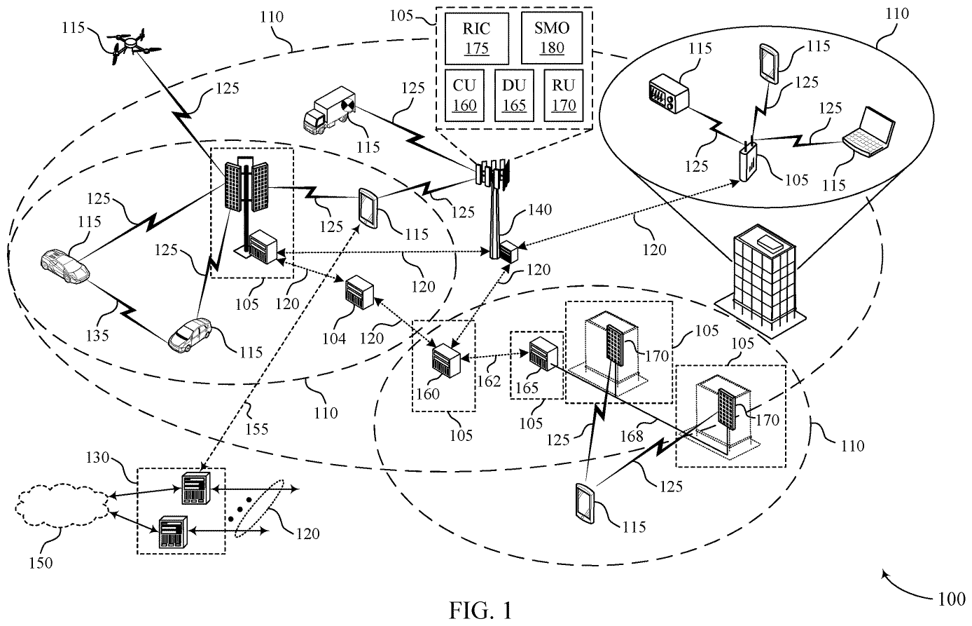

FIG. 1 illustrates an example of a wireless communications system 100 that supports reporting precoding matrix information for multiple candidate TRP groups in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reporting precoding matrix information for multiple candidate TRP groups as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS, which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, the UE 115 may report partial precoding matrix information to a network entity for the purpose of coherent joint transmission (CJT). In some examples, the UE 115 may receive a control message from the network entity 105 indicating a set of TRP groups, where each TRP group of the set of TRP groups includes at least two or more TRPs. Upon receiving the control message, the UE 115 may transmit an indication of one or more first precoding matrix components for each TRP included in the set of TRP groups. In some examples, the one or more first precoding components may include one or more respective spatial domain basis matrices and one or more respective frequency domain matrices. Additionally, the UE 115 may transmit an indication of one or more second precoding matrix components for each TRP group of the set of TRP groups. In some examples, the one or more second precoding matrix components may include one or more respective spatial-frequency coefficient matrices or one or more scalar coefficients. The network entity 105 may then communicate with the UE 115 via a TRP group of the set of TRP groups using a precoding matrix that is determined based on the one or more first precoding components for each TRP in the TRP group and the one or more second precoding matrix components for the TRP group.

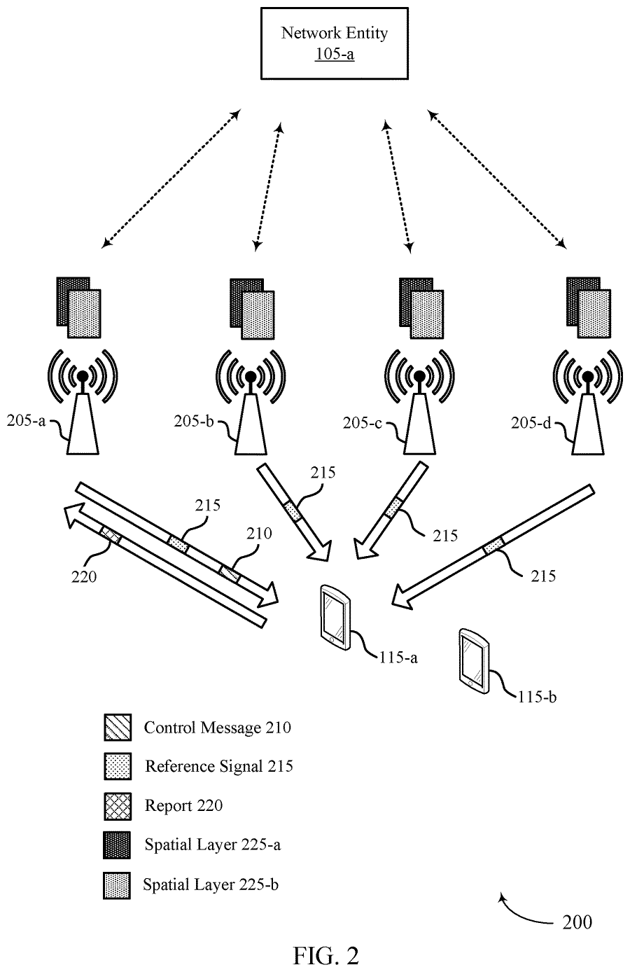

FIG. 2 illustrates an example of a wireless communications system 200 that supports reporting precoding matrix information for multiple candidate TRP groups in accordance with one or more aspects of the present disclosure. In some examples, the wireless communications system 200 may implement aspects of a wireless communications system 100. For example, the wireless communications system 200 may include a network entity 105-a, a UE 115-a, and a UE 115-b which may be examples of a network entity 105 and UEs 115 as described with reference to FIG. 1.

In some examples, the network entity 105-a may communicate with a UE 115 using one or more TRPs 205. The TRPs 205 may act remote antenna for the network entity 105-a and the network entity 105-a may schedule the TRPs 205 to transmit signaling to or receive signaling from the UE 115. Using one or more backhaul link, the TRPs 205 may then relay any information obtained from the UE 115 to the network entity 105-a. FIG. 2 illustrates the TRPs 205 as examples of distributed TRPs 205 (e.g., TRPs 205 separated by some distance), but it is understood that the methods as described herein may also apply to collocated TRPs 205 (e.g., TRPs 205 in the same location or placed together). In some examples, each TRP 205 may support at least two spatial layers 225. For example, each TRP 205 may support a spatial layer 225-a and a spatial layer 225-b. As such, each TRP 205 may have the ability to simultaneously transmit (e.g., over the same time and frequency resources) two streams of data using the two spatial layers 225.

In some examples, the UE 115 may be configured to receive signaling from at least two TRPs 205 (e.g., and up to four TRPs 205) over the same time and frequency resources. This type of communication may be known as JT. There may be two cases of JT, CJT and non-coherent JT. In the case of CJT, the network entity 105-a may have some knowledge about channels between the UE 115 and the TRPs 205 involved in the JT. Alternatively, in the case non-coherent JT, the network entity 105-a may have little to no knowledge of the channel between the UE 115 and the TRPs 205 involved in the JT. As such, to support CJT, the UE 115 may report CSI associated with the TRPs 205 to the network entity 105-a. The UE 115 may determine CSI for each TRP 205 based on measurements of reference signals 215 (e.g., CSI-RSs or synchronization signal block (SSB) signals) received from the TRPs 205. The CSI may include parameters such as one or more of a rank indicator (RI), a PMI, a channel quality indicator (CQI), or a CSI-RS resource indicator (CRI).

The PMI may indicate a preferred precoding matrix (W) to use for downlink transmissions. A transmitting device may utilize the preferred precoding matrix during precoding. In some examples, precoding may be performed to reduce a peak-to-average-power ratio (PAPR) of a transmitted signal. For example, precoding may allow the transmitting device to exploit transmit diversity by weighing the information stream which may reduce the corrupted effects of a channel. In some examples, the preferred precoding matrix is not explicitly signaled, but provided as an index that corresponds to a set of predefined precoding matrices (e.g., codebook). The precoding matrix may be made up of a one or more precoding matrix components. For example, the precoding matrix may be the product of three different matrices. The three different matrices may be a spatial domain basis matrix (W₁), a spatial-frequency domain coefficient matrix (W₂), and a frequency domain basis matrix (W_{f}). A frequency domain basis may represent a frequency range that results in a strongest reception of the reference signals 215 (e.g., signal strength above a threshold) and the spatial domain basis may reflect layer (e.g., spatial layer 225) and port combinations that result in a strongest reception of the reference signals 215 (e.g., signal strength above a threshold). The precoding matrix for a spatial layer 225 may be represented by the Equation 1.

$$W = {W}_{1} \times {\tilde{W}}_{2} \times {W}_{f}^{H} \qquad ( 1 )$$

In some examples, the network entity 105-a may have knowledge of a group of TRPs 205 that the UE 115 will communicate with via JT. As one example, the UE 115-a may be the only UE 115 present in a cell. In such example, the network entity 115-a may employ SU-MIMO and configure the UE 115-a to communicate with a group of TRPs 205 that includes a TRP 205-a, the TRP 205-b, the TRP 205-c, and the TRP 205-d via JT. Because the network entity 105-a has knowledge on the group of TRP 205 for which the UE 115-a may communicate with, the UE 115-a may only report CSI or the PMI for that group of TRPs 205 (e.g., the first group of TRPs 205).

Alternatively, the network entity 105-a may not have knowledge on the group of TRPs 205 that the UE 115 will communicate with via JT. For example, the UE 115-a may not be the only UE 115 present in the cell and there be at least one other UE 115 in the cell. As an example, the cell may include the UE 115-a and the UE 115-b. In such situation, the network entity 105-a may employ either SU-MIMO or MU-MIMO. The network entity 105-a may select between SU-MIMO or MU-MIMO based on which scheme provides a better throughput, but the network entity 105-a may not have knowledge of the throughput until it receives the CSI. As such, the UE 115-a may provide CSI or the PMI for each possible group of TRPs 205 or for each multi-TRP hypothesis. The possible groups of TRPs 205 may include a first group of TRPs 205 that includes the TRP 205-a, the TRP 205-b, the TRP 205-c, and the TRP 205-d, a second group of TRPs 205 that includes the TRP 205-a and the TRP 205-b, and a third group of TRPs 205 that includes the TRP 205-c and the TRP 205-d. But reporting CSI or the PMI for each group of TRPs 205 may significantly increase overhead signaling when compared to reporting CSI or PMI for a single group of TRPs 205 as described above.

As described herein, the UE 115 may report partial CSI or the PMI for candidate groups of TRPs 205 which may reduce overhead signaling when compared to reporting full CSI or the PMI for candidate groups of TRPs 205. In some examples, a UE 115-a may receive a control message 210 (e.g., CSI configuration message) from the network entity 105-a (e.g., via the TRP 205-a). The control message 210 may include an indication of multiple candidate groups of TRPs 205 (e.g., two or more groups of TRPS 205). As one example, the multiple candidate groups of TRPs 205 may include a first group of TRPs 205, a second group of TRPs 205, and a third group of TRPs 205. The first group of TRPs 205 group may include the TRP 205-a, the TRP 205-b, the TRP 205-c, and the TRP 205-d. The second group of TRPs 205 may include the TRP 205-a and the TRP 205-b and the third group of TRPs 205 may include the TRP 205-c and the TRP 205-d. In some examples, the control message 210 may also indicates a set of resources (e.g., CSI-RS resources) and the UE 115-a may receive reference signals 215 (e.g., CSI-RSs) from the TRP 205-a, the TRP 205-b, the TRP 205-c, and the TRP 205-d over the set of resources. Upon receiving the reference signals 215, the UE 115-a may measure the received reference signals 215 and use the measurements of the received reference signals 215 to determine sets of precoding matrix components.

First, the UE 115-a may determine a first set of precoding matrix components. In one alternative, the first set of precoding matrix components may include a spatial domain basis matrix for each of the TRP 205-a, the TRP 205-b, the TRP 205-c, and the TRP 205-d and for each spatial layer (e.g., the spatial layer 225-a and the spatial layer 225-b) of the TRP 205-a, the TRP 205-b, the TRP 205-c, and the TRP 205-d. Additionally, the first set of precoding matrix components may include a frequency domain basis for each of the TRP 205-a, the TRP 205-b, the TRP 205-c, and the TRP 205-d and for each spatial layer (e.g., the spatial layer 225-a and the spatial layer 225-b) of the TRP 205-a, the TRP 205-b, the TRP 205-c, and the TRP 205-d. That is, the first set of precoding matrix components may include 8 spatial domain basis matrices (e.g., one for each spatial layer 225 of each TRP 205) and 8 frequency domain basis matrices (e.g., one for each spatial layer 225 of each TRP 205). Second, the UE 115-a may select a spatial layer 225 (e.g., either the spatial layer 225-a or the spatial layer 225-b) and determine a second set of precoding matrix components. The second set of precoding matrix components may include a spatial-frequency coefficient matrix for each of the first group of TRPs 205, the second group of TRPs 205, and the third group of TRPs 205 and for the selected spatial layer 225. That is, the second set of precoding matrix components may include 8 spatial-frequency coefficient matrices.

In a second alternative, the first set of precoding matrix components may include a spatial domain basis matrix for each of the TRP 205-a, the TRP 205-b, the TRP 205-c, and the TRP 205-d and for each spatial layer (e.g., the spatial layer 225-a and the spatial layer 225-b) of the TRP 205-a, the TRP 205-b, the TRP 205-c, and the TRP 205-d. Additionally, the first set of precoding matrix components may include a frequency domain basis for each of the TRP 205-a, the TRP 205-b, the TRP 205-c, and the TRP 205-d and for each spatial layer (e.g., the spatial layer 225-a and the spatial layer 225-b) of the TRP 205-a, the TRP 205-b, the TRP 205-c, and the TRP 205-d. Moreover, the first set of precoding matrix components may include a spatial-frequency domain coefficient matrix for each of the TRP 205-a, the TRP 205-b, the TRP 205-c, and the TRP 205-d and for each spatial layer (e.g., the spatial layer 225-a and the spatial layer 225-b) of the TRP 205-a, the TRP 205-b, the TRP 205-c, and the TRP 205-d. That is, the first set of precoding matrix components may include 8 spatial domain basis matrices, 8 frequency domain basis matrices and 8 spatial-frequency domain coefficient matrices. The second set of precoding matrix components may include a complex scalar coefficient for each of the first group of TRPs 205, the second group of TRPs 205, and the third group of TRPs 205 and for the selected spatial layer 225. That is, the second set of precoding matrix components may include 8 complex scalar coefficients. The complex scalar coefficient may be described as a quantity of bits that represents a amplitude and a phase value.

Upon determining the first set of precoding matrix components and the second set of precoding matrix components, the UE 115-a may transmit an indication of the first set of precoding matrix components and the second set of precoding matrix components to the network entity 105-a. In some examples, the UE 115-a may transmit the indication in a single report 220 (e.g., a CSI report). In some examples, the UE 115-a may transmit the report 220 to the network entity 105-a via one or more of the TRPs 205. For example, the TRP 105-a may be an example of serving TRP 205 and the UE 115-a may utilize the TRP 205-a to relay the report 220 to the network entity 105-a. Moreover, the UE 115-a may transmit an indication of the selected spatial layer 225 out of the spatial layers 225 for each TRP 205 to the network entity 105-a. In some examples, the UE 115-a may include the indication of the selected spatial layer 225 out of the spatial layers 225 for each TRP 205 in the report 220.

Upon receiving the report 220, the network entity 105-a may select a group of TRPs 205 from the multiple candidate groups of TRPs 205. In some examples, the base station 105-a may select the group of TRPs 205 that has the best throughput. As one example, the network entity 105-a may select the second group of TRPs 205 (e.g., the TRP 205-a and the TRP 205-b). Upon selecting the group of TRPs 205, the network entity 105-a may determine a precoding matrix to utilize when communicating with the UE 115-a via the selected group of TRPs 205. In the case that the network entity 105-a selects the second group of TRPs 205, the network entity 205-a may determine a precoding matrix for communicating with the UE 115-a via the TRP 205-a using a spatial domain basis matrix, a frequency domain basis matrix, a spatial-frequency coefficient matrix, and optionally a scalar coefficient corresponding to the TRP 205-a and the selected spatial layer 225. Moreover, the network entity 205-a may determine a precoding matrix for communicating with the UE 115-a via the TRP 205-b using a spatial domain basis matrix, a frequency domain basis matrix, a spatial-frequency coefficient matrix, and optionally a scalar coefficient corresponding to the TRP 205-b and the selected spatial layer 225. As described herein, the UE 115-a may report the spatial domain basis and the frequency domain basis for each TRP 205 which may be shared among all the multi-TRP hypothesis resulting in a reduction of overhead signaling when compared to reporting the spatial domain basis and the frequency domain basis for each multi-TRP hypothesis individually.

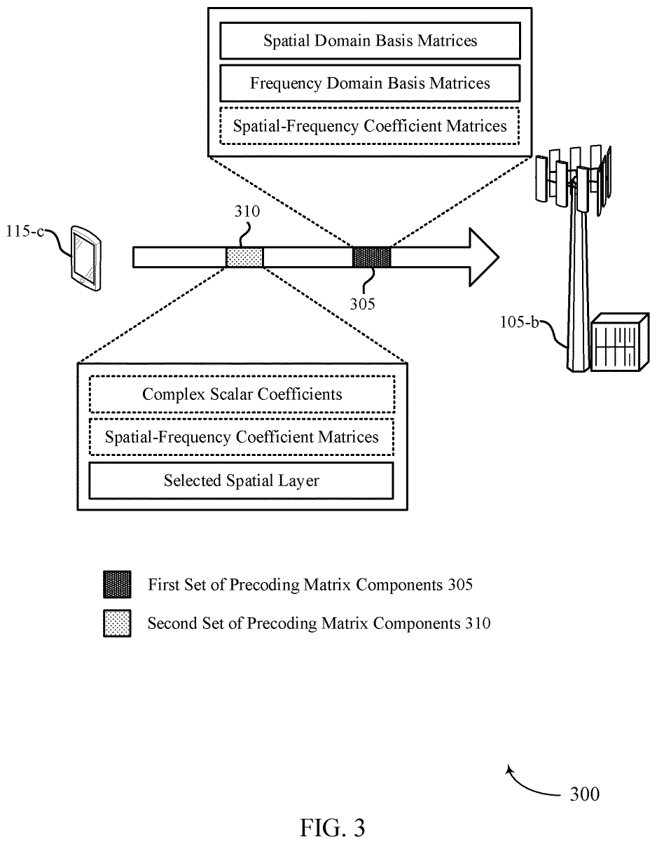

FIG. 3 illustrates an example of a PMI reporting scheme 300 that supports reporting precoding matrix information for multiple candidate TRP groups in accordance with one or more aspects of the present disclosure. In some examples, the PMI reporting scheme 300 may implement aspects of a wireless communications system 100 and a wireless communications system 200. For example, the PMI reporting scheme 300 may include a network entity 105-b and a UE 115-c which may be examples of a network entity 105 and a UE 115 as described with reference to FIGS. 1 and 2.

As described with reference to FIG. 2, the network entity 105-b may transmit control signaling to the UE 115-c indicating multiple TRP hypotheses. A TRP hypothesis may be described as a group of TRPs that may potentially communicate with the UE 115-c via JT. In the example of FIG. 3, the TRP hypotheses may include a first group of TRPs, a second group of TRPs, and a third group of TRPs. The first group of TRPs may include a TRP 1 and a TRP 2. The second group of TRPs may include a TRP 3 and a TRP 4 and the third group of TRPs may include the TRP 1, the TRP 2, the TRP 3, and the TRP 4. Each of the TRP 1, the TRP 2, the TRP 3, and the TRP 4 may support at least a spatial layer 1 and a spatial layer 2.

Upon receiving the control signaling, the UE 115-c may determine a first set of precoding matrix components 305. Table 1 illustrates the first set of precoding matrix components 305 determined by the UE 115-c in a first alternative. W₁^{(s,v)} may represent a spatial domain basis matrix for a TRP s and a spatial layer v and W_{f}^{(s,v)} may represent the frequency domain basis matrix for the TRP s and the spatial layer v. As illustrated in Table 1, the first set of precoding matrix components may include a spatial domain basis matrix and a frequency domain basis matrix for the spatial layer 1 and for each TRP 205 included in one or more of the (e.g., each TRP 205 that is included in at least one of the) TRP hypotheses (e.g., W₁^{(1,1)}, W_{f}^{(1,1)}, W₁^{(2,1)}, W_{f}^{(2,1)}, W₁^{(3,1)}, W_{f}^{(3,1)}, W₁^{(4,1)}, and W_{f}^{(4,1)}. Additionally, the first set of precoding matrix components may include a spatial domain basis matrix and a frequency domain basis matrix for the spatial layer 2 and for each TRP included in one or more of the hypotheses (e.g., W₁^{(1,2)}, W_{f}^{(1,2)}, W₁^{(2,2)}, W_{f}^{(2,2)}, W₁^{(3,2)}, W_{f}^{(3,2)}, W₁^{(4,2)}, and W_{f}^{(4,2)}. In some examples, the UE 115-c may include an indication of the first set of precoding matrix components 305 in a CSI report and transmit the CSI report to the network entity 105-b. In some example, each spatial domain basis matrix (W₁^{(s,v)}) and frequency domain basis matrix (W_{f}^{(s,v)}) may be represented by a PMI in the CSI report.

TABLE 1

| Single-TRP | First Set of Precoding Matrix Components |
|---|---|
| TRP 1 | {W₁^{(1, 1)}, W_{f}^{(1, 1)}}, {W₁^{(1, 2)}, W_{f}^{(1, 2)}} |
| TRP 2 | {W₁^{(2, 1)}, W_{f}^{(2, 1)}}, {W₁^{(2, 2)}, W_{f}^{(2, 2)}} |
| TRP 3 | {W₁^{(3, 1)}, W_{f}^{(3, 1)}}, {W₁^{(3, 2)}, W_{f}^{(3, 2)}} |
| TRP 4 | {W₁^{(4, 1)}, W_{f}^{(4, 1)}}, {W₁^{(4, 2)}, W_{f}^{(4, 2)}} |

In addition to determining the first set of precoding matrix components 305, the UE 115-c may determine a second set of precoding matrix components 310. Table 2 illustrates the second set of precoding matrix components 310 determined by the UE 115-c in the first alternative. W₂^{(k,u,s)} may represent a spatial-frequency coefficient matrix for a TRP hypothesis k, a spatial layer u and a TRP s. As illustrated in Table 2, the UE 115-c may select the spatial layer 1 and as such, the second set of precoding matrix components 310 may include spatial-frequency coefficient matrices for the spatial layer 1 for the first TRP group (e.g., \tilde{W}₂^{(1,1,1)} and \tilde{W}₂^{(1,1,2)}). Additionally, the second set of precoding matrix components 310 may include spatial-frequency coefficient matrices for the spatial layer 1 for the second TRP group (e.g., \tilde{W}₂^{(2,1,3)} and \tilde{W}₂^{(2,1,4)}). Moreover, the second set of precoding matrix components 310 may include spatial-frequency coefficient matrices for the spatial layer 1 for the third TRP group (e.g., \tilde{W}₂^{(3,1,1)}, \tilde{W}₂^{(3,1,2)}, \tilde{W}₂^{(3,1,3)}, and \tilde{W}₂^{(3,1,4)}. In some examples, the UE 115-c may include an indication of the second set of precoding matrix components 310 in the CSI report and transmit the CSI report to the network entity 105-b. In some examples, each spatial-frequency coefficient matrix (\tilde{W}₂^{(k,u,s)}) may be represented by a PMI in the CSI report. Additionally, the UE 115-c may transmit indications of the selected spatial layer out of the spatial layers for each TRP to the network entity 105-b (e.g., v_{k,u,s}).

TABLE 2

| TRP Hypotheses | Second Set of Precoding Matrix Components |
|---|---|
| TRP 1, TRP 2 | \tilde{W}₂^{(1, 1, 1)}, \tilde{W}₂^{(1, 1, 2)} |
| TRP 3, TRP 4 | \tilde{W}₂^{(2, 1, 3)}, \tilde{W}₂^{(2, 1, 4)} |
| TRP 1, TRP 2, | \tilde{W}₂^{(3, 1, 1)}, \tilde{W}₂^{(3, 1, 2)}, \tilde{W}₂^{(3, 1, 3)}, \tilde{W}₂^{(3, 1, 4)} |
| TRP 3, TRP 4 | |

The UE 115-c may transmit the indication of the first set of precoding matrix components 305 and the indication of the second set of precoding matrix components 310 together (e.g., as part of a single message) or separately (e.g., as part of two or more messages). Upon receiving the indication of the first set of precoding matrix components 305 and the indication of the second set of precoding matrix components 310, the network entity 105-b may select a TRP hypothesis and determine a precoding matrix for the TRP hypothesis using the first set of precoding components 305 and the second set of precoding matrix components 310. Table 3 illustrates a precoding matrix that the network entity 105-b may determine for each TRP hypothesis in the first alternative. As illustrated in Table 3, the network entity 105-b may select the first TRP group and determine a precoding matrix to use to communicate with the UE 115-c via TRP 1 and the TRP 2. The network entity 105-b may determine the precoding matrix to use to communicate with the UE 115-c via TRP 1 using the spatial domain basis matrix and the frequency domain basis matrix corresponding to the spatial layer 1 of the TRP1 (e.g., W₁^{(1,1)}, W_{f}^{(1,1)}) and the spatial-frequency coefficient matrix (e.g., \tilde{W}₂^{(1,1,1)}). The network entity 105-b may determine a precoding matrix to use to communicate with the UE 115-c via the TRP 2 using the spatial domain basis matrix and the frequency domain basis matrix corresponding to the spatial layer 1 of the TRP 2 (e.g., W₁^{(2,1)}, W_{f}^{(2,1)}) and the spatial-frequency coefficient matrix (e.g., \tilde{W}₂^{(1,1,2)}).

Also, as illustrated in Table 3, the network entity 105-b may select the second TRP group and determine a precoding matrix to use to communicate with the UE 115-c via TRP 3 and the TRP 4. The network entity 105-b may determine the precoding matrix to use to communicate with the UE 115-c via TRP 3 using the spatial domain basis matrix and the frequency domain basis matrix, and the spatial-frequency coefficient matrix corresponding to the spatial layer 1 of the TRP 3 (e.g., W₁^{(3,1)}, W_{f}^{(3,1)}) and the spatial-frequency coefficient matrix (e.g., \tilde{W}₂^{(2,1,3)}). The network entity 105-b may determine a precoding matrix to use to communicate with the UE 115-c via the TRP 4 using the spatial domain basis matrix and the frequency domain basis matrix corresponding to the spatial layer 1 of the TRP 4 (e.g., W₁^{(4,1)}, W_{f}^{(4,1)}) and the spatial-frequency coefficient matrix (e.g., \tilde{W}₂^{(2,1,4)}).

Moreover, as illustrated in Table 3, the network entity 105-b may select the third TRP group and determine a precoding matrix to use to communicate with the UE 115-c via TRP 1, the TRP 2, the TRP 3 and the TRP 4. The network entity 105-b may determine the precoding matrix to use to communicate with the UE 115-c via TRP 1 using the spatial domain basis matrix and the frequency domain basis matrix corresponding to the spatial layer 1 of the TRP 1 (e.g., W₁^{(1,1)}, W_{f}^{(1,1)}) and the spatial-frequency coefficient matrix (e.g., \tilde{W}₂^{(3,1,1)}). The network entity 105-b may determine a precoding matrix to use to communicate with the UE 115-c via the TRP 2 using the spatial domain basis matrix and the frequency domain basis matrix corresponding to the spatial layer 1 of the TRP 2 (e.g., W₁^{(2,1)}, W_{f}^{(2,1)}) and the spatial-frequency coefficient matrix (e.g., \tilde{W}₂^{(3,1,2)}, The network entity 105-b may determine a precoding matrix to use to communicate with the UE 115-c via the TRP 3 using the spatial domain basis matrix and the frequency domain basis matrix corresponding to the spatial layer 1 of the TRP 3 (e.g., W₁^{(3,1)}, W_{f}^{(3,1)}) and the spatial-frequency coefficient matrix (e.g., \tilde{W}₂^{(3,1,3)}). The network entity 105-b may determine a precoding matrix to use to communicate with the UE 115-c via the TRP 4 using the spatial domain basis matrix and the frequency domain basis corresponding to the spatial layer 1 of the TRP 4 (e.g., W₁^{(4,1)}, W_{f}^{(4,1)}) and the spatial-frequency coefficient matrix (e.g., \tilde{W}₂^{(3,1,4)}).

TABLE 3

| TRP Hypothesis | Precoding Matrix |
|---|---|
| TRP 1, TRP 2 | W₁^{(1, 1)} × \tilde{W}₂^{(1, 1, 1)} × W_{f}^{(1, 1)}^{^{H}}, |
| | W₁^{(2, 1)} × \tilde{W}₂^{(1, 1, 2)} × W_{f}^{(2, 1)}^{^{H}} |
| TRP 3, TRP 4 | W₁^{(3, 1)} × \tilde{W}₂^{(2, 1, 3)} × W_{f}^{(3, 1)}^{^{H}}, |
| | W₁^{(4, 1)} × \tilde{W}₂^{(2, 1, 4)} × W_{f}^{(4, 1)}^{^{H}} |
| TRP 1, TRP 2, | W₁^{(1, 1)} × \tilde{W}₂^{(3, 1, 1)} × W_{f}^{(1, 1)}^{^{H}}, |
| TRP 3, TRP 4 | W₁^{(2, 1)} × \tilde{W}₂^{(3, 1, 2)} × W_{f}^{(2, 1)}^{^{H}}, |
| | W₁^{(3, 1)} × \tilde{W}₂^{(3, 1, 3)} × W_{f}^{(3, 1)}^{^{H}}, |
| | W₁^{(4, 1)} × \tilde{W}₂^{(3, 1, 4)} × W_{f}^{(4, 1)}^{^{H}} |

Table 4 illustrates the first set of precoding matrix components 305 determined by the UE 115-c in a second alternative. W₁^{(s,v)} may represent a spatial domain basis matrix for a TRP s and a spatial layer v, W_{f}^{(s,v)} may represent the frequency domain basis matrix for the TRP s and a spatial layer v, and W₂^{(s,v)} may represent the spatial-frequency coefficient matrix for the TRP s and a spatial layer v. As illustrated in Table 4, the first set of precoding matrix components may include a spatial domain basis matrix, a frequency domain basis matrix, and a spatial-frequency coefficient matrix for the spatial layer 1 and for each TRP 205 included in one or more of the TRP hypotheses (e.g., W₁^{(1,1)}, W_{f}^{(1,1)}, \tilde{W}₂^{(1,1)}, W₁^{(2,1)}, W_{f}^{(2,1)}, \tilde{W}₂^{(2,1)}, W₁^{(3,1)}, W_{f}^{(3,1)}, \tilde{W}₂^{(3,1)}, W₁^{(4,1)}, W_{f}^{(4,1)}, and \tilde{W}₂^{(4,1)}). Additionally, the first set of precoding matrix components may include a spatial domain basis matrix, a frequency domain basis matrix, and a spatial-frequency coefficient matrix for the spatial layer 2 and for each TRP included in one or more of the hypotheses (e.g., W₁^{(1,2)}, W_{f}^{(1,2)}, \tilde{W}₂^{(1,2)}, W₁^{(2,2)}, W_{f}^{(2,2)}, \tilde{W}₂^{(2,2)}, W₁^{(3,2)}, W_{f}^{(3,2)}, \tilde{W}₂^{(3,2)}, W₁^{(4,2)}, W_{f}^{(4,2)}, and \tilde{W}₂^{(4,2)})). In some examples, the UE 115-c may include an indication of the first set of precoding matrix components 305 in a CSI report and transmit the CSI report to the network entity 105-b. In some example, each spatial domain basis matrix (W₁^{(s,v)}), frequency domain basis matrix (W_{f}^{(s,v)}, and spatial-frequency coefficient matrix (\tilde{W}₂^{(s,v)}) may be represented by a PMI in the CSI report.

TABLE 4

| Single-TRP | First Set of Precoding Matrix Components |
|---|---|
| TRP 1 | {W₁^{(1, 1)}, \tilde{W}₂^{(1, 1)}, W_{f}^{(1, 1)}}, {W₁^{(1, 2)}, \tilde{W}₂^{(1, 2)}, W_{f}^{(1, 2)}} |
| TRP 2 | {W₁^{(2, 1)}, \tilde{W}₂^{(2, 1)}, W_{f}^{(2, 1)}}, {W₁^{(2, 2)}, \tilde{W}₂^{(2, 2)}, W_{f}^{(2, 2)}} |
| TRP 3 | {W₁^{(3, 1)}, \tilde{W}₂^{(3, 1)}, W_{f}^{(3, 1)}}, {W₁^{(3, 2)}, \tilde{W}₂^{(3, 2)}, W_{f}^{(3, 2)},} |
| TRP 4 | {W₁^{(4, 1)}, \tilde{W}₂^{(4, 1)}, W_{f}^{(4, 1)}}, {W₁^{(4, 2)}, \tilde{W}₂^{(4, 2)}, W_{f}^{(4, 2)}} |

In addition to determining the first set of precoding matrix components 305, the UE 115-c may determine a second set of precoding matrix components 310. Table 5 illustrates the second set of precoding matrix components 310 determined by the UE 115-c in the second alternative. α^{(k,u,s)} may represent a scalar coefficient for a TRP hypothesis k, a spatial layer u and a TRP s. As illustrated in Table 5, the UE 115-c may select the spatial layer 1 and the second set of precoding matrix components 310 may include scalar coefficients for the spatial layer 1 for the first TRP group (e.g., α^{(1,1,1)} and α^{(1,1,2)}). Additionally, the second set of precoding matrix components 310 may include scalar coefficients for the spatial layer 1 for the second TRP group (e.g., α^{(2,1,3)} and α^{(2,1,4)}). Moreover, the second set of precoding matrix components 310 may include scalar coefficients for the spatial layer 1 for the third TRP group (e.g., α^{(3,1,1)}, α^{(3,1,2)} α^{(3,1,3)}, and α^{(3,1,4)}). In some examples, the UE 115-c may include an indication of the second set of precoding matrix components 310 in the CSI report and transmit the CSI report to the network entity 105-b. Additionally, the UE 115-c may transmit an indication of the selected spatial layer out of the spatial layers for each TRP to the network entity 105-b (e.g., v_{k,u,s}).

TABLE 5

| TRP Hypotheses | Second Set of Precoding Matrix Components |
|---|---|
| TRP 1, TRP 2 | α^{(1, 1, 1)}, α^{(1, 1, 2)} |
| TRP 3, TRP 4 | α^{(2, 1, 3)}, α^{(2, 1, 4)} |
| TRP 1, TRP 2, | α^{(3, 1, 1)}, α^{(3, 1, 2)}, α^{(3, 1, 3)}, α^{(3, 1, 4)} |
| TRP 3, TRP 4 | |

Upon receiving the indication of the first set of one or more precoding matrix components 305 and the second set of precoding matrix components 310, the network entity 105-b may select a TRP hypothesis and determine a precoding matrix for the TRP hypothesis using the first set of one or more precoding components 305 and the second set of precoding matrix components. Table 6 illustrates a precoding matrix that the network entity 105-b may determine for each TRP hypothesis in the second alternative. As illustrated in Table 6, the network entity 105-b may select the first TRP group and determine a precoding matrix to use to communicate with the UE 115-c via TRP 1 and the TRP 2. The network entity 105-b may determine to use to communicate with the UE 115-c via TRP 1 using the spatial domain basis matrix, the frequency domain basis matrix, and the spatial-frequency coefficient matrix corresponding to the spatial layer 1 of the TRP 1 (e.g., W₁^{(1,1)}, \tilde{W}₂^{(1,1)}, W_{f}^{(1,1)}) and the scalar coefficient (e.g., α^{(1,1,1)}). The network entity 105-b may determine a precoding matrix to use to communicate with the UE 115-c via the TRP 2 using the spatial domain basis matrix, the frequency domain basis matrix, and the spatial-frequency coefficient matrix corresponding to the spatial layer 1 of the TRP 2 (e.g., W₁^{(2,1)}, \tilde{W}₂^{(2,1)}, W_{f}^{(2,1)}) and the scalar coefficient (e.g., α^{(1,1,2)}).

Also, as illustrated in Table 6, the network entity 105-b may select the second TRP group and determine a precoding matrix to use to communicate with the UE 115-c via TRP 3 and the TRP 4. The network entity 105-b may determine the precoding matrix to use to communicate with the UE 115-c via TRP 3 using the spatial domain basis matrix, the frequency domain basis matrix, and the spatial-frequency coefficient matrix corresponding to the spatial layer 1 of the TRP 3 (e.g., W₁^{(3,1)}, \tilde{W}₂^{(3,1)}, W_{f}^{(3,1)}) and the scalar coefficient (e.g., α^{(2,1,3)}). The network entity 105-b may determine a precoding matrix to use to communicate with the UE 115-c via the TRP 4 using the spatial domain basis matrix, the frequency domain basis matrix, and the spatial-frequency coefficient matrix corresponding to the spatial layer 1 of the TRP 4 (e.g., W₁^{(4,1)}, \tilde{W}₂^{(4,4)}, W_{f}^{(4,1)}) and the scalar coefficient (e.g., α^{(2,1,4)}).

Moreover, as illustrated in Table 6, the network entity 105-b may select the third TRP group and determine a precoding matrix to use to communicate with the UE 115-c via TRP 1, the TRP 2, the TRP 3 and the TRP 4. The network entity 105-b may determine the precoding matrix to use to communicate with the UE 115-c via TRP 1 using the spatial domain basis matrix, the frequency domain basis matrix, and the spatial-frequency coefficient matrix corresponding to the spatial layer 1 of the TRP 1 (e.g., W₁^{(1,1)}, \tilde{W}₂^{(1,1)}, W_{f}^{(1,1)}) and the scalar coefficient (e.g., α^{(3,1,1)}). The network entity 105-b may determine a precoding matrix to use to communicate with the UE 115-c via the TRP 2 using the spatial domain basis matrix, the frequency domain basis, and the spatial-frequency coefficient matrix corresponding to the spatial layer 1 of the TRP 2 (e.g., W₁^{(2,1)}, \tilde{W}₂^{(2,1)}, W_{f}^{(2,1)}) and the scalar coefficient (e.g., α^{(3,1,2)}). The network entity 105-b may determine a precoding matrix to use to communicate with the UE 115-c via the TRP 3 using the spatial domain basis matrix, the frequency domain basis matrix, and the spatial-frequency coefficient matrix corresponding to the spatial layer 1 of the TRP 3 (e.g., W₁^{(3,1)}, \tilde{W}₂^{(3,1)}, W_{f}^{(3,1)}) and the scalar coefficient (e.g., α^{(3,1,3)}). The network entity 105-b may determine a precoding matrix to use to communicate with the UE 115-c via the TRP 4 using the spatial domain basis matrix, the frequency domain basis matrix, and the spatial-frequency coefficient matrix corresponding to the spatial layer 1 of the TRP 4 (e.g., W₁^{(4,1)}, \tilde{W}₂^{(4,1)}, W_{f}^{(4,1)}) and the scalar coefficient (e.g., α^{(3,1,4)}).

TABLE 6

| TRP Hypothesis | Precoding Matrix |
|---|---|
| TRP 1, TRP 2 | α^{(1, 1, 1)} × W₁^{(1, 1)} × W₂^{(1, 1)} × W_{f}^{(1, 1)}^{^{H}}, |
| | α^{(1, 1, 2)} × W₁^{(2, 1)} × W₂^{(2, 1)} × W_{f}^{(2, 1)}^{^{H}} |
| TRP 3, TRP 4 | α^{(2, 1, 3)} × W₁^{(3, 1)} × W₂^{(3, 1)} × W_{f}^{(3, 1)}^{^{H}}, |
| | α^{(2, 1, 4)} × W₁^{(4, 1)} × W₂^{(4, 1)} × W_{f}^{(4, 1)}^{^{H}} |
| TRP 1, TRP 2, | α^{(3, 1, 1)} × W₁^{(1, 1)} × W₂^{(1, 1)} × W_{f}^{(1, 1)}^{^{H}}, |
| TRP 3, TRP 4 | α^{(3, 1, 2)} × W₁^{(2, 1)} × W₂^{(2, 1)} × W_{f}^{(2, 1)}^{^{H}}, |
| | α^{(3, 1, 3)} × W₁^{(3, 1)} × W₂^{(3, 1)} × W_{f}^{(3, 1)}^{^{H}}, |
| | α^{(3, 1, 4)} × W₁^{(4, 1)} × W₂^{(4, 1)} × W_{f}^{(4, 1)}^{^{H}} |

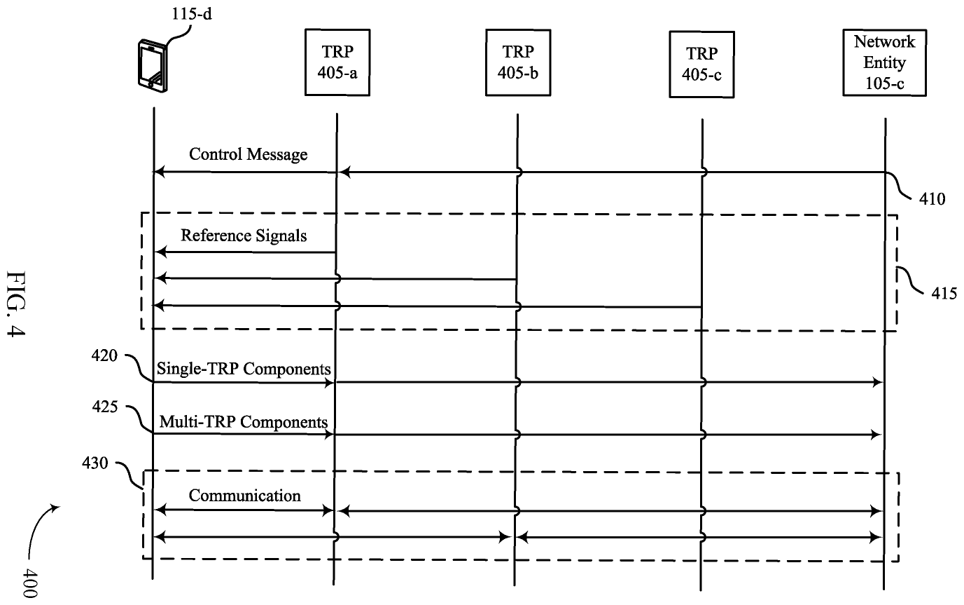

FIG. 4 illustrates an example of a process flow 400 that supports reporting precoding matrix information for multiple candidate TRP groups in accordance with one or more aspects of the present disclosure. In some examples, the process flow 400 may be implemented by aspects of a wireless communications system 100, a wireless communications system 200, and a PMI reporting scheme 300. For example, the process flow 400 may be implemented by a UE 115-d, a network entity 105-c, a TRP 405-a, a TRP 405-b, and a TRP 405-c which may be examples of a UE 115, a network entity 105, and TRPs 205 as described with reference to FIG. 1-3. Alternative examples of the following may be implemented, where some steps are performed in a different order than described or are not performed at all. In some cases, steps may include additional features not mentioned below, or furth steps may be added.

At 410, the UE 115-d may receive a control message from the network entity 105-c. In some examples, the network entity 105-c may transmit the control message to the UE 115-d via a TRP 405. For example, the network entity 105-c may transmit the control message to the TRP 405-a and the TRP 405-a may transmit the control message to the UE 115-d. In some examples, the control message may indicate a set of TRP groups that includes two or more TRPs 405. As an example, the set of TRP groups may include a first TRP group that includes the TRP 405-a and the TRP 405-b and a second TRP group that includes the TRP 405-b and a TRP 405-c. In some examples, the set of TRP groups may be candidate groups for communicating with the UE 115-d via JT. Additionally, the control message may indicate a set of resources for receiving reference signals from the TRPs 405. In some examples (e.g., where two or more procedures for reporting precoding matrix information are supported), the control message may also indicate a procedure for reporting precoding matrix information (e.g., a procedure included in a set of two or more candidate procedures for reporting the precoding matrix information, where a first procedure includes transmitting, for each TRP group that is included in the plurality of TRP groups, an indication of one or more respective spatial-frequency coefficient matrices, and where a second procedure comprises transmitting, for each TRP group that is included in the plurality of TRP groups, an indication of one or more respective scalar coefficients). In other examples, a separate control message (distinct from the one that indicates the set of TRP groups) may indicate a procedure for reporting precoding matrix information.

At 415, the UE 115-d may receive reference signals from the TRP 405-a, the TRP 405-b, and the TRP 405-c over the set of resources. In some examples, the UE 115-d may determine measurements (e.g., RSRP, SINR, or RSSI) of the received reference signals.

At 420, the UE 115-d may transmit, for each TRP 405 that is included in one or more of the TRP groups, an indication of one or more single-TRP precoding matrix components to the network entity 105-c (e.g., via the TRP 405-a). For example, the UE 115-d may transmit an indication of one or more single-TRP precoding matrix components for each of the TRP 405-a, the TRP 405-b, and the TRP 405-c. In one example, the one or more single-TRP precoding matrix components may include an indication of one or more respective spatial domain basis matrices or one or more respective frequency domain basis matrices. In some examples, the one or more single-TRP precoding matrix components may further include one or more spatial-frequency coefficient matrices. In some examples, the one or more single-TRP precoding matrix components include at least one single-TRP precoding matrix component for each single-TRP spatial layer of the TRP 405.

At 425, the UE 115-d may transmit, for each TRP group that is included in the set of TRP groups, an indication of one or more respective multi-TRP precoding matrix components to the network entity 105-c (e.g., via the TRP 405-a). For example, the UE 115-d may transmit an indication of the one or more multi-TRP precoding matrix component for each of the first TRP group and the second TRP group. In one example, the one or more multi-TRP precoding matrix components may include an indication of one or more respective spatial-frequency coefficient matrices. In another example, the one or more multi-TRP precoding matrix components may include an indication of one or more respective scalar coefficients. In such example, the UE 115-d may receive a second control message (e.g., from the network entity 105-c) indicating a first quantity of bits for encoding each of a respective amplitude of the scalar coefficients and a second quantity of bits for encoding each of the respective phase of the scalar coefficients. Though illustrates separately in the example of FIG. 4 at 420 and 425 for enhanced clarity of illustration, it is to be understood that transmitting the indication of one or more single-TRP precoding matrix components and transmitting the indication of one or more respective multi-TRP precoding matrix components by the UE 115-d to the network entity 105-c may be performed (e.g., accomplished) by transmitting a single message or by transmitting any quantity of separate messages.

In some examples, the UE 115-d may select a multi-TRP spatial layer for each TRP group and determine, for each TRP group, the one or more respective multi-TRP precoding matrix components based on the respective selected multi-TRP spatial layer. In some cases, the UE 115-d may transmit an indication of the selected multi-TRP spatial layer to the network entity 105-c.

In some examples, the UE 115-d may receive, prior to receiving the reference signals at 415, a control message that indicate a procedure for reporting precoding matrix information. The indicated procedure may be included in a set of two or more candidate procedures for reporting the precoding matrix information. A first procedure in the set of two or more candidate procedure may include transmitting, for each TRP group that is included in the set of TRP groups, the indication of the one or more spatial-frequency coefficient matrices and a second procedure in the set of two or more candidate procedure may include transmitting, for each TRP group that is included in the set of TRP groups, the indication of the one or more scalar coefficients.

At 430, the network entity 105-c may communicate with the UE 115-d via a TRP group (e.g., the first TRP group) of the set of TRP groups using a precoding matrix. In some examples, the precoding matrix may be based on a combination of the one or more respective multi-TRP precoding matrix components for the selected TRP group and the one or more respective single-TRP precoding matrix components for each TRP included in the TRP group.

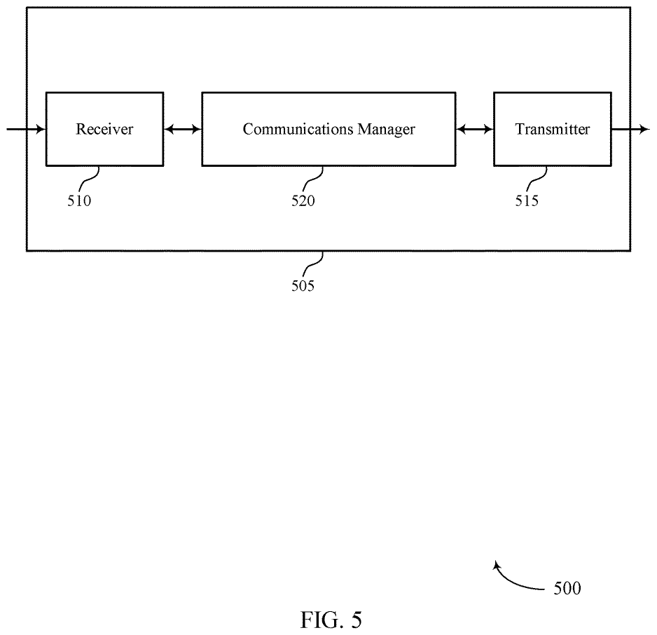

FIG. 5 shows a block diagram 500 of a device 505 that supports reporting precoding matrix information for multiple candidate TRP groups in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to reporting precoding matrix information for multiple candidate TRP groups). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to reporting precoding matrix information for multiple candidate TRP groups). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of reporting precoding matrix information for multiple candidate TRP groups as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving an indication of a set of multiple TRP groups that include two or more TRPs, where the set of multiple TRP groups are candidate TRP groups for communicating with the UE via JT. The communications manager 520 may be configured as or otherwise support a means for transmitting, for each TRP that is included in one or more of the multiple TRP groups, an indication of one or more respective single-TRP precoding matrix components. The communications manager 520 may be configured as or otherwise support a means for transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing and more efficient utilization of communication resources.

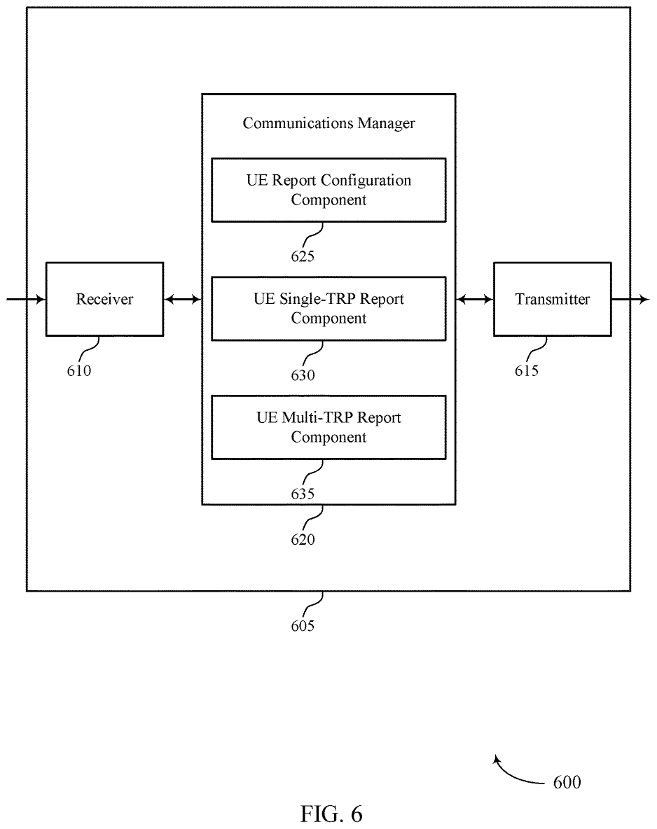

FIG. 6 shows a block diagram 600 of a device 605 that supports reporting precoding matrix information for multiple candidate TRP groups in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to reporting precoding matrix information for multiple candidate TRP groups). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reporting precoding matrix information for multiple candidate TRP groups). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of reporting precoding matrix information for multiple candidate TRP groups as described herein. For example, the communications manager 620 may include a UE report configuration component 625, a UE single-TRP report component 630, a UE multi-TRP report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The UE report configuration component 625 may be configured as or otherwise support a means for receiving an indication of a set of multiple TRP groups that include two or more TRPs, where the set of multiple TRP groups are candidate TRP groups for communicating with the UE via JT. The UE single-TRP report component 630 may be configured as or otherwise support a means for transmitting, for each TRP that is included in one or more of the multiple TRP groups, an indication of one or more respective single-TRP precoding matrix components. The UE multi-TRP report component 635 may be configured as or otherwise support a means for transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

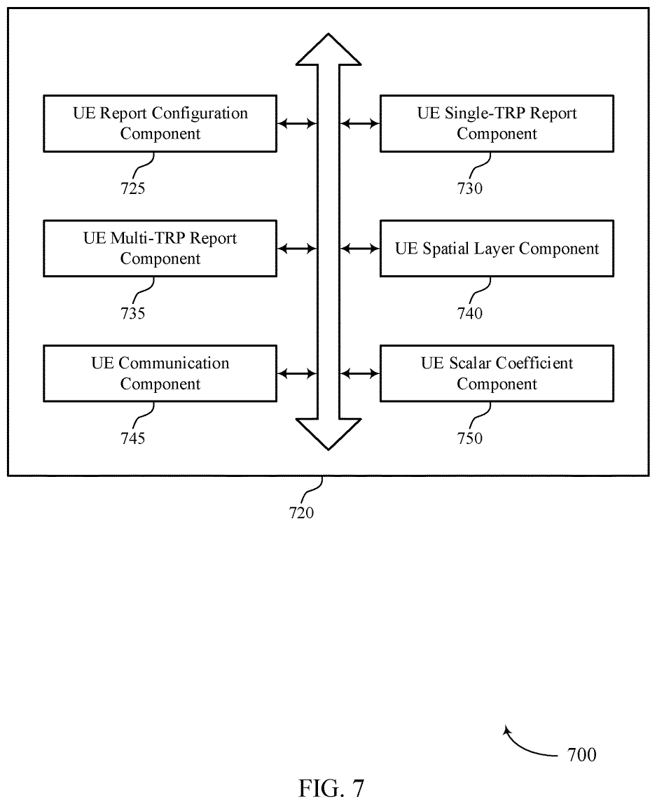

FIG. 7 shows a block diagram 700 of a communications manager 720 that supports reporting precoding matrix information for multiple candidate TRP groups in accordance with one or more aspects of the present disclosure. The communications manager 720 may be an example of aspects of a communications manager 520, a communications manager 620, or both, as described herein. The communications manager 720, or various components thereof, may be an example of means for performing various aspects of reporting precoding matrix information for multiple candidate TRP groups as described herein. For example, the communications manager 720 may include a UE report configuration component 725, a UE single-TRP report component 730, a UE multi-TRP report component 735, a UE spatial layer component 740, a UE communication component 745, a UE scalar coefficient component 750, or any combination thereof. Each of these components may communicate, directly or indirectly, with one another (e.g., via one or more buses).

The communications manager 720 may support wireless communication at a UE in accordance with examples as disclosed herein. The UE report configuration component 725 may be configured as or otherwise support a means for receiving an indication of a set of multiple TRP groups that include two or more TRPs, where the set of multiple TRP groups are candidate TRP groups for communicating with the UE via JT. The UE single-TRP report component 730 may be configured as or otherwise support a means for transmitting, for each TRP that is included in one or more of the multiple TRP groups, an indication of one or more respective single-TRP precoding matrix components. The UE multi-TRP report component 735 may be configured as or otherwise support a means for transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

In some examples, to support transmitting the indication of the one or more respective single-TRP precoding matrix components, the UE single-TRP report component 730 may be configured as or otherwise support a means for transmitting, for each TRP that is included in one or more of the multiple TRP groups, an indication of one or more respective spatial domain basis matrices, one or more respective frequency domain basis matrices, or any combination thereof.

In some examples, to support transmitting the indication of the one or more respective multi-TRP precoding matrix components, the UE multi-TRP report component 735 may be configured as or otherwise support a means for transmitting, for each TRP group that is included in the set of multiple TRP groups, an indication of one or more respective spatial-frequency coefficient matrices.

In some examples, to support transmitting the indication of the one or more respective single-TRP precoding matrix components, the UE single-TRP report component 730 may be configured as or otherwise support a means for transmitting, for each TRP that is included in one or more of the multiple TRP groups, an indication of one or more respective spatial-frequency coefficient matrices.

In some examples, to support transmitting the indication of the one or more respective multi-TRP precoding matrix components, the UE multi-TRP report component 735 may be configured as or otherwise support a means for transmitting, for each TRP group that is included in the set of multiple TRP groups, an indication of one or more respective scalar coefficients.

In some examples, each of the one or more respective scalar coefficients includes a respective amplitude and a respective phase, and the UE scalar coefficient component 750 may be configured as or otherwise support a means for receiving a control message indicating a first quantity of bits for encoding each of the respective amplitudes and a second quantity of bits for encoding each of the respective phases, where the indication of the one or more scalar coefficients is based on the encoding each of the respective amplitudes using the first quantity of bits and encoding each of the respective phases using the second quantity of bits.

In some examples, for each TRP that is included in one or more of the multiple TRP groups, the one or more single-TRP precoding matrix components include at least one single-TRP precoding matrix component for each single-TRP spatial layer of each TRP.

In some examples, the set of multiple TRP groups includes a first TRP group, and the UE spatial layer component 740 may be configured as or otherwise support a means for selecting a respective single-TRP spatial layer from each TRP that is included in the first TRP group, the selected single-TRP spatial layers corresponding to a first multi-TRP spatial layer of the first TRP group. In some examples, the set of multiple TRP groups includes a first TRP group, and the UE multi-TRP report component 735 may be configured as or otherwise support a means for determining the one or more respective multi-TRP precoding matrix components for the first TRP group based on the selected single-TRP spatial layers.

In some examples, the UE spatial layer component 740 may be configured as or otherwise support a means for transmitting an indication of the selected single-TRP spatial layers corresponding to the first multi-TRP spatial layer of the first TRP group.

In some examples, the UE report configuration component 725 may be configured as or otherwise support a means for receiving a control message that indicates a procedure for reporting precoding matrix information, the indicated procedure included in a set of two or more candidate procedures for reporting the precoding matrix information that includes a first procedure and a second procedure. In some examples, the UE multi-TRP report component 735 may be configured as or otherwise support a means for performing the indicated procedure for reporting the precoding matrix information, where the first procedure includes transmitting, for each TRP group that is included in the set of multiple TRP groups, an indication of one or more respective spatial-frequency coefficient matrices, and the second procedure includes transmitting, for each TRP group that is included in the set of multiple TRP groups, an indication of one or more respective scalar coefficients. Responsive to the first procedure being indicated, transmitting the indication of the one or more respective multi-TRP precoding matrix components for each TRP group included in the plurality of TRP groups includes transmitting an indication of one or more respective spatial-frequency coefficient matrices for each TRP group included in the plurality of TRP groups. Responsive to the second procedure being indicated, transmitting the indication of the one or more respective multi-TRP precoding matrix components for each TRP group included in the plurality of TRP groups includes transmitting an indication of one or more respective scalar coefficients for each TRP group included in the plurality of TRP groups.

In some examples, the UE communication component 745 may be configured as or otherwise support a means for communicating with the TRP group via JT based on the precoding matrix.

In some examples, the indication of the set of multiple TRP groups is received as part of a channel state information reporting configuration message; and the indications of the one or more respective single-TRP precoding matrix components and the indications of the one or more respective multi-TRP precoding matrix components are transmitted as part of a channel state information report.

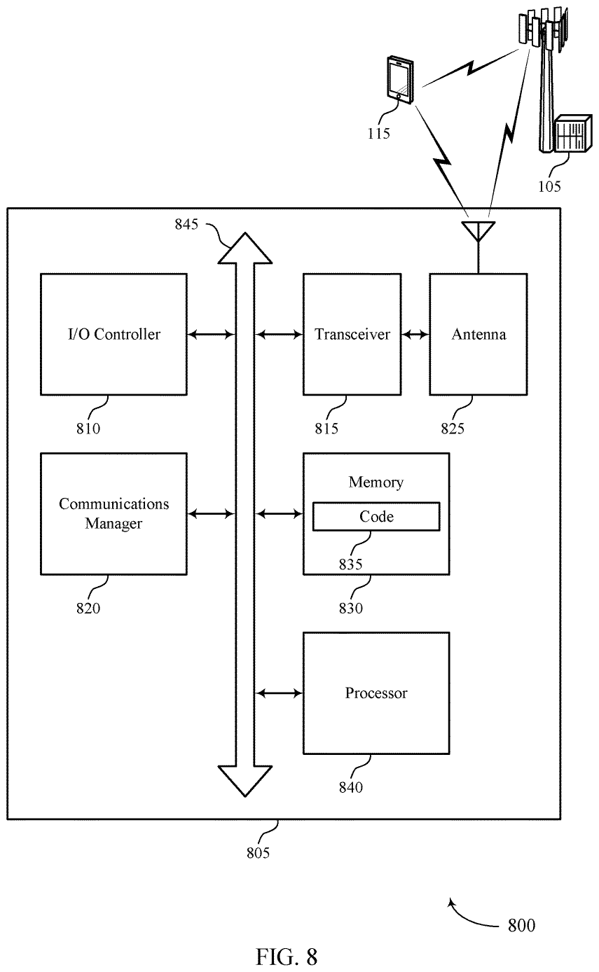

FIG. 8 shows a diagram of a system 800 including a device 805 that supports reporting precoding matrix information for multiple candidate TRP groups in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting reporting precoding matrix information for multiple candidate TRP groups). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving an indication of a set of multiple TRP groups that include two or more TRPs, where the set of multiple TRP groups are candidate TRP groups for communicating with the UE via JT. The communications manager 820 may be configured as or otherwise support a means for transmitting, for each TRP that is included in one or more of the multiple TRP groups, an indication of one or more respective single-TRP precoding matrix components. The communications manager 820 may be configured as or otherwise support a means for transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group.

By including or configuring the communications manager 820 in accordance with examples as described herein, the device 805 may support techniques for reduced latency, more efficient utilization of communication resources, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of reporting precoding matrix information for multiple candidate TRP groups as described herein, or the processor 840 and the memory 830 may be otherwise configured to perform or support such operations.

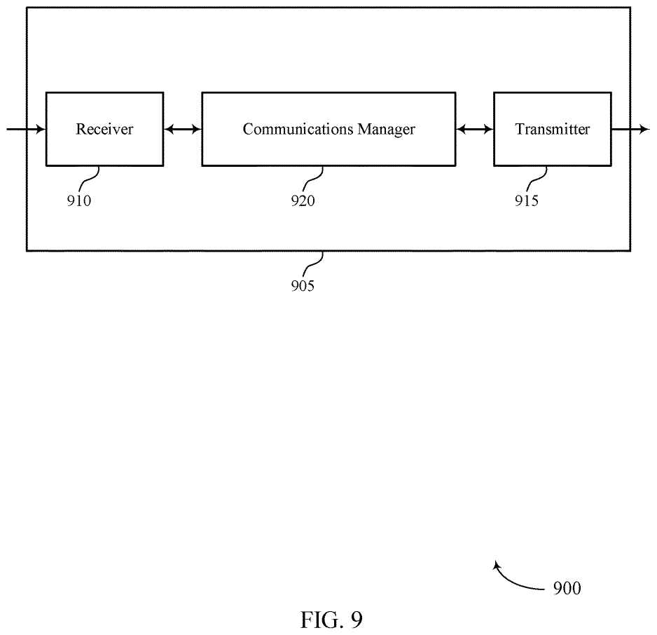

FIG. 9 shows a block diagram 900 of a device 905 that supports reporting precoding matrix information for multiple candidate TRP groups in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of reporting precoding matrix information for multiple candidate TRP groups as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting an indication of a set of multiple TRP groups that include two or more TRPs, where the set of multiple TRP groups are candidate TRP groups for communicating with a UE via JT. The communications manager 920 may be configured as or otherwise support a means for receiving, for each TRP that is included in one or more of the multiple TRP groups, an indication of one or more respective single-TRP precoding matrix components. The communications manager 920 may be configured as or otherwise support a means for receiving, for each TRP group that is included in the set of multiple TRP groups, an indication of one or more respective multi-TRP precoding matrix components. The communications manager 920 may be configured as or otherwise support a means for determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and more efficient utilization of communication resources.

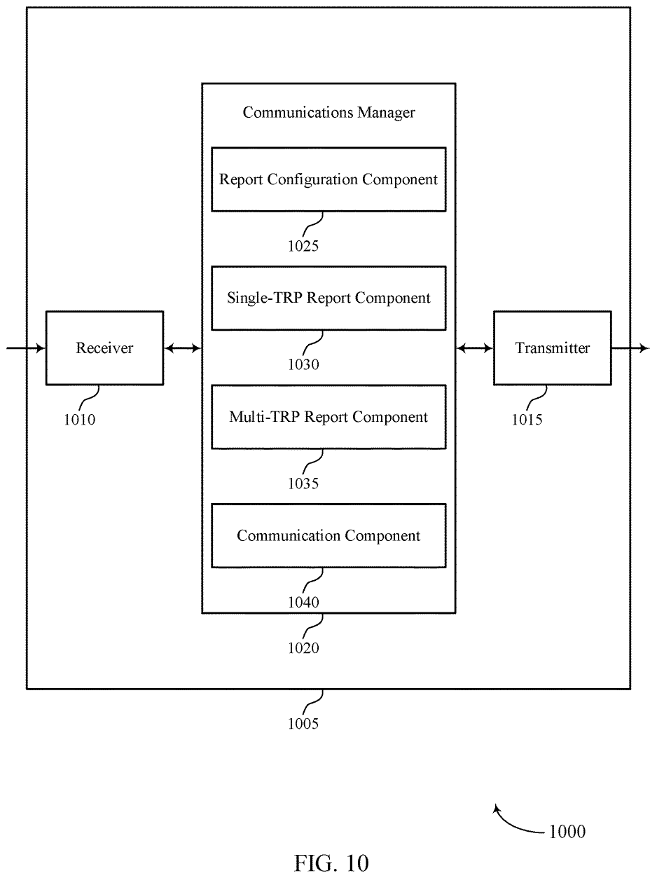

FIG. 10 shows a block diagram 1000 of a device 1005 that supports reporting precoding matrix information for multiple candidate TRP groups in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of reporting precoding matrix information for multiple candidate TRP groups as described herein. For example, the communications manager 1020 may include a report configuration component 1025, a single-TRP report component 1030, a multi-TRP report component 1035, a communication component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The report configuration component 1025 may be configured as or otherwise support a means for transmitting an indication of a set of multiple TRP groups that include two or more TRPs, where the set of multiple TRP groups are candidate TRP groups for communicating with a UE via JT. The single-TRP report component 1030 may be configured as or otherwise support a means for receiving, for each TRP that is included in one or more of the multiple TRP groups, an indication of one or more respective single-TRP precoding matrix components. The multi-TRP report component 1035 may be configured as or otherwise support a means for receiving, for each TRP group that is included in the set of multiple TRP groups, an indication of one or more respective multi-TRP precoding matrix components. The communication component 1040 may be configured as or otherwise support a means for determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

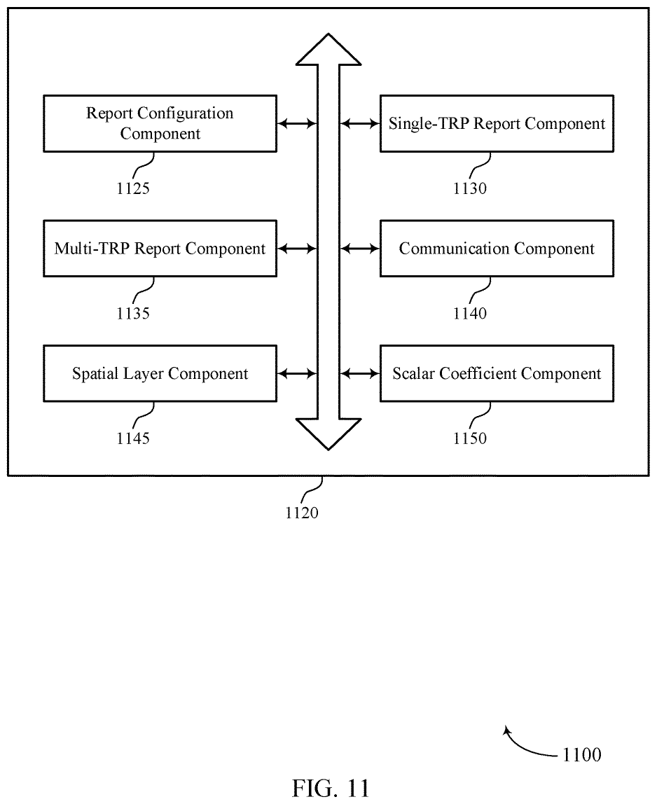

FIG. 11 shows a block diagram 1100 of a communications manager 1120 that supports reporting precoding matrix information for multiple candidate TRP groups in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of reporting precoding matrix information for multiple candidate TRP groups as described herein. For example, the communications manager 1120 may include a report configuration component 1125, a single-TRP report component 1130, a multi-TRP report component 1135, a communication component 1140, a spatial layer component 1145, a scalar coefficient component 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The report configuration component 1125 may be configured as or otherwise support a means for transmitting an indication of a set of multiple TRP groups that include two or more TRPs, where the set of multiple TRP groups are candidate TRP groups for communicating with a UE via JT. The single-TRP report component 1130 may be configured as or otherwise support a means for receiving, for each TRP that is included in one or more of the multiple TRP groups, an indication of one or more respective single-TRP precoding matrix components. The multi-TRP report component 1135 may be configured as or otherwise support a means for receiving, for each TRP group that is included in the set of multiple TRP groups, an indication of one or more respective multi-TRP precoding matrix components. The communication component 1140 may be configured as or otherwise support a means for determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

In some examples, to support receiving the indication of the one or more respective single-TRP precoding matrix components, the single-TRP report component 1130 may be configured as or otherwise support a means for receiving, for each TRP that is included in one or more of the multiple TRP groups, an indication of one or more respective spatial domain basis matrices, one or more respective frequency domain basis matrices, or any combination thereof.

In some examples, to support receiving the indication of the one or more respective multi-TRP precoding matrix components, the multi-TRP report component 1135 may be configured as or otherwise support a means for receiving, for each TRP group that is included in the set of multiple TRP groups, an indication of one or more respective spatial-frequency coefficient matrices.

In some examples, to support receiving the indication of the one or more respective single-TRP precoding matrix components, the single-TRP report component 1130 may be configured as or otherwise support a means for receiving, for each TRP that is included in one or more of the multiple TRP groups, an indication of one or more respective spatial-frequency coefficient matrices.

In some examples, to support receiving the indication of the one or more respective multi-TRP precoding matrix components, the multi-TRP report component 1135 may be configured as or otherwise support a means for receiving, for each TRP group that is included in the set of multiple TRP groups, an indication of one or more respective scalar coefficients.

In some examples, each of the one or more respective scalar coefficients includes a respective amplitude and a respective phase, and the scalar coefficient component 1150 may be configured as or otherwise support a means for transmitting a control message indicating a first quantity of bits for encoding each of the respective amplitudes and a second quantity of bits for encoding each of the respective phases, where the indication of the one or more scalar coefficients is based on the each of the respective amplitudes being encoded using the first quantity of bits and each of the respective phases being encoded using the second quantity of bits.

In some examples, for each TRP that is included in one or more of the multiple TRP groups, the one or more single-TRP precoding matrix components include at least one single-TRP precoding matrix component for each single-TRP spatial layer of each TRP.

In some examples, the set of multiple TRP groups includes a first TRP group, and the spatial layer component 1145 may be configured as or otherwise support a means for receiving an indication of selected single-TRP spatial layers corresponding to a first multi-TRP spatial layer of the first TRP group, where the selected single-TRP spatial layers include a respective single-TRP spatial layer from each TRP that is included in the first TRP group and the one or more respective multi-TRP precoding matrix components for the first TRP group are based on the selected single-TRP spatial layers.

In some examples, the multi-TRP report component 1135 may be configured as or otherwise support a means for transmitting a control message that indicates a procedure for reporting precoding matrix information, the indicated procedure included in a set of two or more candidate procedures for reporting the precoding matrix information that includes a first procedure and a second procedure, where the first procedure includes the UE transmitting (and the network entity receiving), for each TRP group that is included in the set of multiple TRP groups, an indication of one or more respective spatial-frequency coefficient matrices, the second procedure includes the UE transmitting (and the network entity receiving), for each TRP group that is included in the set of multiple TRP groups, an indication of one or more respective scalar coefficients, and the indications of the one or more respective single-TRP precoding matrix components and the indications of the one or more respective multi-TRP precoding matrix components are in accordance with the indicated procedure for reporting the precoding matrix information. Responsive to the first procedure being indicated, receiving the indication of the one or more respective multi-TRP precoding matrix components for each TRP group included in the plurality of TRP groups includes receiving an indication of one or more respective spatial-frequency coefficient matrices for each TRP group included in the plurality of TRP groups. Responsive to the second procedure being indicated, receiving the indication of the one or more respective multi-TRP precoding matrix components for each TRP group included in the plurality of TRP groups includes receiving an indication of one or more respective scalar coefficients for each TRP group included in the plurality of TRP groups.

In some examples, the communication component 1140 may be configured as or otherwise support a means for communicating with the UE via the TRP group and JT based on the precoding matrix.

In some examples, the indication of the plurality TRP groups is transmitted as part of a channel state information reporting configuration message and the indications of the one or more respective single-TRP precoding matrix components and the indications of the one or more respective multi-TRP precoding matrix components are received as part of a channel state information report.

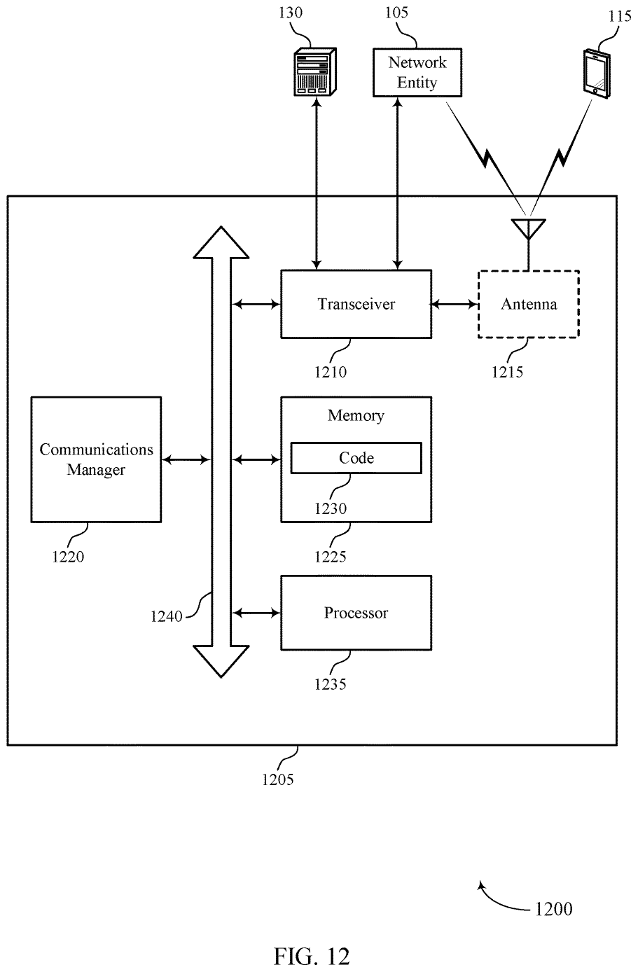

FIG. 12 shows a diagram of a system 1200 including a device 1205 that supports reporting precoding matrix information for multiple candidate TRP groups in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting reporting precoding matrix information for multiple candidate TRP groups). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting an indication of a set of multiple TRP groups that include two or more TRPs, where the set of multiple TRP groups are candidate TRP groups for communicating with a UE via JT. The communications manager 1220 may be configured as or otherwise support a means for receiving, for each TRP that is included in one or more of the multiple TRP groups, an indication of one or more respective single-TRP precoding matrix components. The communications manager 1220 may be configured as or otherwise support a means for receiving, for each TRP group that is included in the set of multiple TRP groups, an indication of one or more respective multi-TRP precoding matrix components. The communications manager 1220 may be configured as or otherwise support a means for determining a precoding matrix for a TRP group of the set of multiple TRP groups based on a combination of the one or more respective multi-TRP precoding matrix components for the TRP group and the one or more respective single-TRP precoding matrix components for each TRP included in the TRP group.

By including or configuring the communications manager 1220 in accordance with examples as described herein, the device 1205 may support techniques for reduced latency, more efficient utilization of communication resources, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of reporting precoding matrix information for multiple candidate TRP groups as described herein, or the processor 1235 and the memory 1225 may be otherwise configured to perform or support such operations.

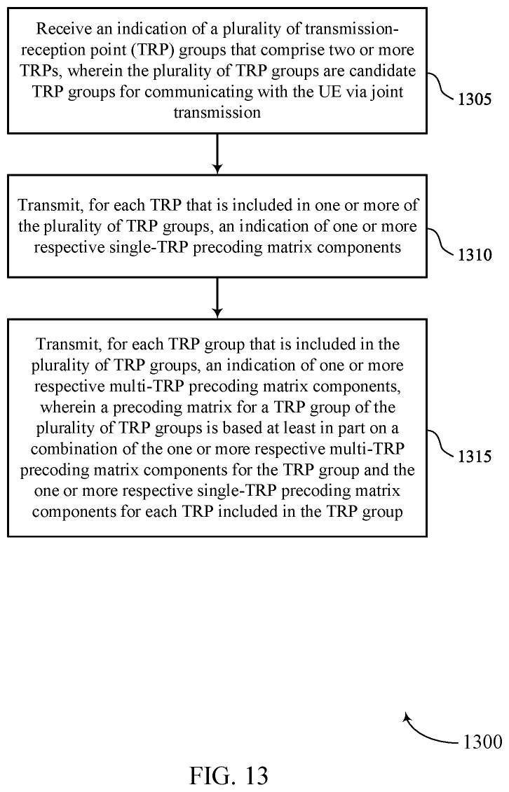

FIG. 13 shows a flowchart illustrating a method 1300 that supports reporting precoding matrix information for multiple candidate TRP groups in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a set of multiple TRP groups that include two or more TRPs, where the set of multiple TRP groups are candidate TRP groups for communicating with the UE via JT. The operations of 1305 may be performed in accordance with examples as disclosed herein. In some examples, aspects of the operations of 1305 may be performed by a UE report configuration component 725 as described with reference to FIG. 7. Additionally or alternatively, means for performing 1305 may, but not necessarily, include, for example, antenna 825, transceiver 815, communications manager 820, memory 830 (including code 835), processor 840 and/or bus 845.

At 1310, the method may include transmitting, for each TRP that is included in one or more of the multiple TRP groups, an indication of one or more respective single-TRP precoding matrix components. The operations of 1310 may be performed in accordance with examples as disclosed herein. In some examples, aspects of the operations of 1310 may be performed by a UE single-TRP report component 730 as described with reference to FIG. 7. Additionally or alternatively, means for performing 1310 may, but not necessarily, include, for example, antenna 825, transceiver 815, communications manager 820, memory 830 (including code 835), processor 840 and/or bus 845.

At 1315, the method may include transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group. The operations of 1315 may be performed in accordance with examples as disclosed herein. In some examples, aspects of the operations of 1315 may be performed by a UE multi-TRP report component 735 as described with reference to FIG. 7. Additionally or alternatively, means for performing 1315 may, but not necessarily, include, for example, antenna 825, transceiver 815, communications manager 820, memory 830 (including code 835), processor 840 and/or bus 845.

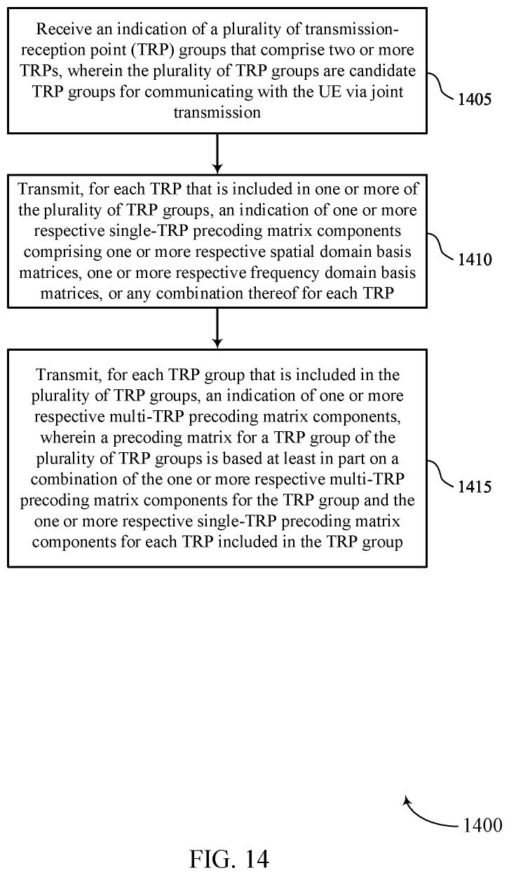

FIG. 14 shows a flowchart illustrating a method 1400 that supports reporting precoding matrix information for multiple candidate TRP groups in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a set of multiple TRP groups that include two or more TRPs, where the set of multiple TRP groups are candidate TRP groups for communicating with the UE via JT. The operations of 1405 may be performed in accordance with examples as disclosed herein. In some examples, aspects of the operations of 1405 may be performed by a UE report configuration component 725 as described with reference to FIG. 7. Additionally or alternatively, means for performing 1405 may, but not necessarily, include, for example, antenna 825, transceiver 815, communications manager 820, memory 830 (including code 835), processor 840 and/or bus 845.

At 1410, the method may include transmitting, for each TRP that is included in one or more of the multiple TRP groups, an indication of one or more respective single-TRP precoding matrix components comprising one or more respective spatial domain basis matrices, one or more respective frequency domain basis matrices, or any combination thereof. The operations of 1410 may be performed in accordance with examples as disclosed herein. In some examples, aspects of the operations of 1410 may be performed by a UE single-TRP report component 730 as described with reference to FIG. 7. Additionally or alternatively, means for performing 1410 may, but not necessarily, include, for example, antenna 825, transceiver 815, communications manager 820, memory 830 (including code 835), processor 840 and/or bus 845.

At 1415, the method may include transmitting, for each TRP group that is included in the set of multiple TRP groups, an indication of one or more respective multi-TRP precoding matrix components, where a precoding matrix for a TRP group of the set of multiple TRP groups is based on a combination of the one or more respective multi-TRP precoding matrix components for the TRP group and the one or more respective single-TRP precoding matrix components for each TRP included in the TRP group. The operations of 1415 may be performed in accordance with examples as disclosed herein. In some examples, aspects of the operations of 1415 may be performed by a UE multi-TRP report component 735 as described with reference to FIG. 7. Additionally or alternatively, means for performing 1415 may, but not necessarily, include, for example, antenna 825, transceiver 815, communications manager 820, memory 830 (including code 835), processor 840 and/or bus 845.

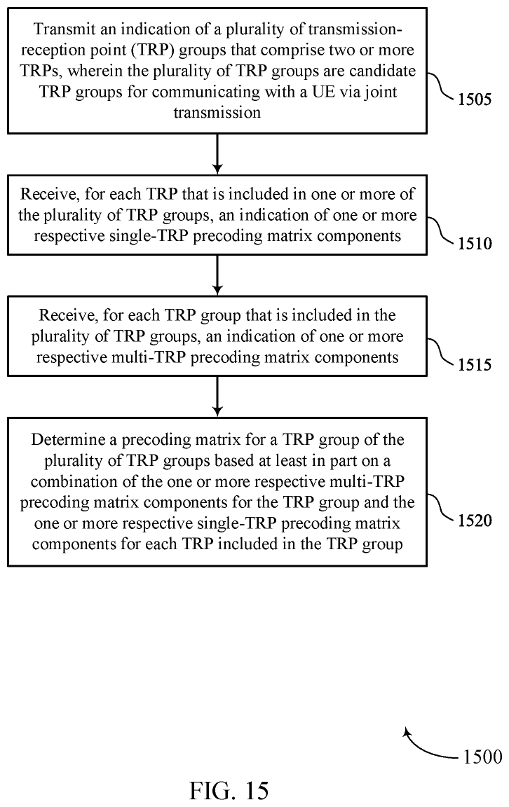

FIG. 15 shows a flowchart illustrating a method 1500 that supports reporting precoding matrix information for multiple candidate TRP groups in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting an indication of a set of multiple TRP groups that include two or more TRPs, where the set of multiple TRP groups are candidate TRP groups for communicating with a UE via JT. The operations of 1505 may be performed in accordance with examples as disclosed herein. In some examples, aspects of the operations of 1505 may be performed by a report configuration component 1125 as described with reference to FIG. 11. Additionally or alternatively, means for performing 1505 may, but not necessarily, include, for example, antenna 1215, transceiver 1210, communications manager 1220, memory 1225 (including code 1230), processor 1235 and/or bus 1240.

At 1510, the method may include receiving, for each TRP that is included in one or more of the multiple TRP groups, an indication of one or more respective single-TRP precoding matrix components. The operations of 1510 may be performed in accordance with examples as disclosed herein. In some examples, aspects of the operations of 1510 may be performed by a single-TRP report component 1130 as described with reference to FIG. 11. Additionally or alternatively, means for performing 1510 may, but not necessarily, include, for example, antenna 1215, transceiver 1210, communications manager 1220, memory 1225 (including code 1230), processor 1235 and/or bus 1240.

At 1515, the method may include receiving, for each TRP group that is included in the set of multiple TRP groups, an indication of one or more respective multi-TRP precoding matrix components. The operations of 1515 may be performed in accordance with examples as disclosed herein. In some examples, aspects of the operations of 1515 may be performed by a multi-TRP report component 1135 as described with reference to FIG. 11. Additionally or alternatively, means for performing 1515 may, but not necessarily, include, for example, antenna 1215, transceiver 1210, communications manager 1220, memory 1225 (including code 1230), processor 1235 and/or bus 1240.

At 1520, the method may include determining a precoding matrix for a TRP group of the set of multiple TRP groups based on a combination of the one or more respective multi-TRP precoding matrix components for the TRP group and the one or more respective single-TRP precoding matrix components for each TRP included in the TRP group. The operations of 1520 may be performed in accordance with examples as disclosed herein. In some examples, aspects of the operations of 1520 may be performed by a communication component 1140 as described with reference to FIG. 11. Additionally or alternatively, means for performing 1520 may, but not necessarily, include, for example, antenna 1215, transceiver 1210, communications manager 1220, memory 1225 (including code 1230), processor 1235 and/or bus 1240.

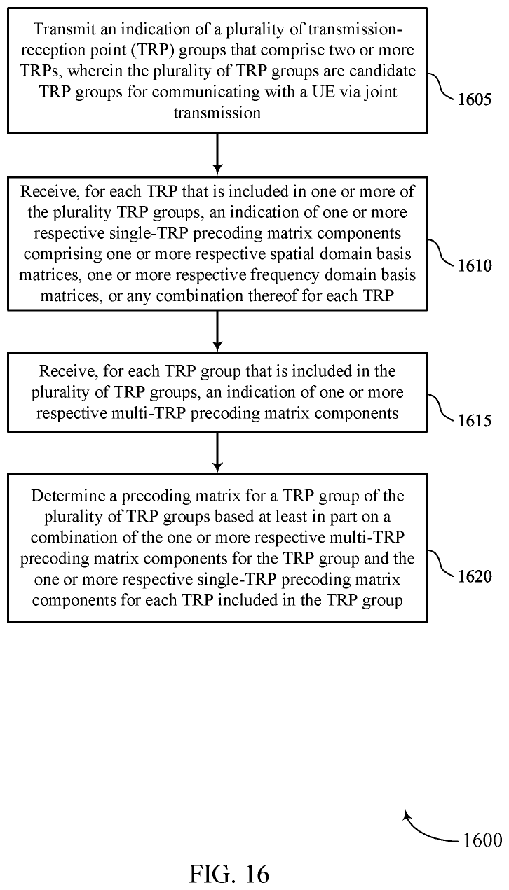

FIG. 16 shows a flowchart illustrating a method 1600 that supports reporting precoding matrix information for multiple candidate TRP groups in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting an indication of a set of multiple TRP groups that include two or more TRPs, where the set of multiple TRP groups are candidate TRP groups for communicating with a UE via JT. The operations of 1605 may be performed in accordance with examples as disclosed herein. In some examples, aspects of the operations of 1605 may be performed by a report configuration component 1125 as described with reference to FIG. 11. Additionally or alternatively, means for performing 1605 may, but not necessarily, include, for example, antenna 1215, transceiver 1210, communications manager 1220, memory 1225 (including code 1230), processor 1235 and/or bus 1240.

At 1610, the method may include receiving, for each TRP that is included in one or more of the multiple TRP groups, an indication of one or more respective single-TRP precoding matrix components comprising one or more respective spatial domain basis matrices, one or more respective frequency domain basis matrices, or any combination thereof. The operations of 1610 may be performed in accordance with examples as disclosed herein. In some examples, aspects of the operations of 1610 may be performed by a single-TRP report component 1130 as described with reference to FIG. 11. Additionally or alternatively, means for performing 1610 may, but not necessarily, include, for example, antenna 1215, transceiver 1210, communications manager 1220, memory 1225 (including code 1230), processor 1235 and/or bus 1240.

At 1615, the method may include receiving, for each TRP group that is included in the set of multiple TRP groups, an indication of one or more respective multi-TRP precoding matrix components. The operations of 1615 may be performed in accordance with examples as disclosed herein. In some examples, aspects of the operations of 1615 may be performed by a multi-TRP report component 1135 as described with reference to FIG. 11. Additionally or alternatively, means for performing 1615 may, but not necessarily, include, for example, antenna 1215, transceiver 1210, communications manager 1220, memory 1225 (including code 1230), processor 1235 and/or bus 1240.

At 1620, the method may include determining a precoding matrix for a TRP group of the set of multiple TRP groups based on a combination of the one or more respective multi-TRP precoding matrix components for the TRP group and the one or more respective single-TRP precoding matrix components for each TRP included in the TRP group. The operations of 1620 may be performed in accordance with examples as disclosed herein. In some examples, aspects of the operations of 1620 may be performed by a communication component 1140 as described with reference to FIG. 11. Additionally or alternatively, means for performing 1620 may, but not necessarily, include, for example, antenna 1215, transceiver 1210, communications manager 1220, memory 1225 (including code 1230), processor 1235 and/or bus 1240.

The following provides an overview of aspects of the present disclosure:

Aspect 1: A method for wireless communication at a UE, comprising: receiving an indication of a plurality of TRP groups that comprise two or more TRPs, wherein the plurality of TRP groups are candidate TRP groups for communicating with the UE via joint transmission; transmitting, for each TRP that is included in one or more of the plurality of TRP groups, an indication of one or more respective single-TRP precoding matrix components; and transmitting, for each TRP group that is included in the plurality of TRP groups, an indication of one or more respective multi-TRP precoding matrix components, wherein a precoding matrix for a TRP group of the plurality of TRP groups is based at least in part on a combination of the one or more respective multi-TRP precoding matrix components for the TRP group and the one or more respective single-TRP precoding matrix components for each TRP included in the TRP group.

Aspect 2: The method of aspect 1, wherein transmitting the indication of the one or more respective single-TRP precoding matrix components comprises: transmitting, for each TRP that is included in one or more of the plurality of TRP groups, an indication of one or more respective spatial domain basis matrices, one or more respective frequency domain basis matrices, or any combination thereof.

Aspect 3: The method of aspect 2, wherein transmitting the indication of the one or more respective multi-TRP precoding matrix components comprises: transmitting, for each TRP group that is included in the plurality of TRP groups, an indication of one or more respective spatial-frequency coefficient matrices.

Aspect 4: The method of aspect 2, wherein transmitting the indication of the one or more respective single-TRP precoding matrix components further comprises: transmitting, for each TRP that is included in one or more of the plurality of TRP groups, an indication of one or more respective spatial-frequency coefficient matrices.

Aspect 5: The method of aspect 4, wherein transmitting the indication of the one or more respective multi-TRP precoding matrix components comprises: transmitting, for each TRP group that is included in the plurality of TRP groups, an indication of one or more respective scalar coefficients.

Aspect 6: The method of aspect 5, wherein each of the one or more respective scalar coefficients comprises a respective amplitude and a respective phase, the method further comprising: receiving a control message indicating a first quantity of bits for encoding each of the respective amplitudes and a second quantity of bits for encoding each of the respective phases, wherein the indication of the one or more scalar coefficients is based at least in part on the encoding each of the respective amplitudes using the first quantity of bits and encoding each of the respective phases using the second quantity of bits.

Aspect 7: The method of any of aspects 1 through 6, wherein for each TRP that is included in one or more of the plurality of TRP groups, the one or more single-TRP precoding matrix components comprise at least one single-TRP precoding matrix component for each single-TRP spatial layer of each TRP.

Aspect 8: The method of any of aspects 1 through 7, wherein the plurality of TRP groups comprises a first TRP group, and wherein each TRP that is included in the first TRP group supports at least a respective first single-TRP spatial layer and a respective second single-TRP spatial layers, the method further comprising: selecting a respective single-TRP spatial layer from each TRP that is included in the first TRP group, the selected single-TRP spatial layers corresponding to a first multi-TRP spatial layer of the first TRP group; and determining the one or more respective multi-TRP precoding matrix components for the first TRP group based at least in part on the selected single-TRP spatial layers.

Aspect 9: The method of aspect 8, further comprising: transmitting an indication of the selected single-TRP spatial layers corresponding to the first multi-TRP spatial layer of the first TRP group.

Aspect 10: The method of any of aspects 1 through 9, further comprising: receiving a control message that indicates a procedure for reporting precoding matrix information, the indicated procedure included in a set of two or more candidate procedures for reporting the precoding matrix information that comprises a first procedure and a second procedure, wherein: responsive to the first procedure being indicated, transmitting the indication of the one or more respective multi-TRP precoding matrix components for each TRP group included in the plurality of TRP groups comprises transmitting an indication of one or more respective spatial-frequency coefficient matrices for each TRP group included in the plurality of TRP groups; and responsive to the second procedure being indicated, transmitting the indication of the one or more respective multi-TRP precoding matrix components for each TRP group included in the plurality of TRP groups comprises transmitting an indication of one or more respective scalar coefficients for each TRP group included in the plurality of TRP groups.

Aspect 11: The method of any of aspects 1 through 10, further comprising: communicating with the TRP group via joint transmission based at least in part on the precoding matrix.

Aspect 12: The method of any of aspects 1 through 11, wherein the indication of the plurality of TRP groups is received as part of a CSI reporting configuration message and the indications of the one or more respective single-TRP precoding matrix components and the indications of the one or more respective multi-TRP precoding matrix components are transmitted as part of a CSI report.

Aspect 13: A method for wireless communication at a network entity, comprising: transmitting an indication of a plurality of TRP groups that comprise two or more TRPs, wherein the plurality of TRP groups are candidate TRP groups for communicating with a UE via joint transmission; receiving, for each TRP that is included in one or more of the plurality of TRP groups, an indication of one or more respective single-TRP precoding matrix components; receiving, for each TRP group that is included in the plurality of TRP groups, an indication of one or more respective multi-TRP precoding matrix components; and determining a precoding matrix for a TRP group of the plurality of TRP groups based at least in part on a combination of the one or more respective multi-TRP precoding matrix components for the TRP group and the one or more respective single-TRP precoding matrix components for each TRP included in the TRP group.

Aspect 14: The method of aspect 13, wherein receiving the indication of the one or more respective single-TRP precoding matrix components comprises: receiving, for each TRP that is included in one or more of the plurality of TRP groups, an indication of one or more respective spatial domain basis matrices, one or more respective frequency domain basis matrices, or any combination thereof.

Aspect 15: The method of aspect 14, wherein receiving the indication of the one or more respective multi-TRP precoding matrix components comprises: receiving, for each TRP group that is included in the plurality of TRP groups, an indication of one or more respective spatial-frequency coefficient matrices.

Aspect 16: The method of aspect 14, wherein receiving the indication of the one or more respective single-TRP precoding matrix components further comprises: receiving, for each TRP that is included in one or more of the plurality of TRP groups, an indication of one or more respective spatial-frequency coefficient matrices.

Aspect 17: The method of aspect 16, wherein receiving the indication of the one or more respective multi-TRP precoding matrix components comprises: receiving, for each TRP group that is included in the plurality of TRP groups, an indication of one or more respective scalar coefficients.

Aspect 18: The method of aspect 17, wherein each of the one or more respective scalar coefficients comprises a respective amplitude and a respective phase, the method further comprising: transmitting a control message indicating a first quantity of bits for encoding each of the respective amplitudes and a second quantity of bits for encoding each of the respective phases, wherein the indication of the one or more scalar coefficients is based at least in part on the each of the respective amplitudes being encoded using the first quantity of bits and each of the respective phases being encoded using the second quantity of bits.

Aspect 19: The method of any of aspects 13 through 18, wherein for each TRP that is included in one or more of the plurality of TRP groups, the one or more single-TRP precoding matrix components comprise at least one single-TRP precoding matrix component for each single-TRP spatial layer of each TRP.

Aspect 20: The method of any of aspects 13 through 19, wherein the plurality of TRP groups comprises a first TRP group, and wherein each TRP that is included in the first TRP group supports at least a respective first single-TRP spatial layer and a respective second single-TRP spatial layers, the method further comprising: receiving an indication of selected single-TRP spatial layers corresponding to a first multi-TRP spatial layer of the first TRP group, wherein the selected single-TRP spatial layers comprise a respective single-TRP spatial layer from each TRP that is included in the first TRP group and the one or more respective multi-TRP precoding matrix components for the first TRP group are based at least in part on the selected single-TRP spatial layers.

Aspect 21: The method of any of aspects 13 through 20, further comprising: transmitting a control message that indicates a procedure for reporting precoding matrix information, the indicated procedure included in a set of two or more candidate procedures for reporting the precoding matrix information that comprises a first procedure and a second procedure, wherein: responsive to the first procedure being indicated, receiving the indication of the one or more respective multi-TRP precoding matrix components for each TRP group included in the plurality of TRP groups includes receiving an indication of one or more respective spatial-frequency coefficient matrices for each TRP group included in the plurality of TRP groups; and responsive to the second procedure being indicated, receiving the indication of the one or more respective multi-TRP precoding matrix components for each TRP group included in the plurality of TRP groups incudes receiving an indication of one or more respective scalar coefficients for each TRP group included in the plurality of TRP groups.

Aspect 22: The method of any of aspects 13 through 21, further comprising: communicating with the UE via the TRP group and joint transmission based at least in part on the precoding matrix.

Aspect 23: The method of any of aspects 13 through 22, wherein the indication of the plurality TRP groups is transmitted as part of a CSI reporting configuration message and the indications of the one or more respective single-TRP precoding matrix components and the indications of the one or more respective multi-TRP precoding matrix components are received as part of a CSI report.

Aspect 24: An apparatus for wireless communication at a UE, comprising a memory, a transceiver, and at least one processor coupled with the memory and the transceiver, the at least one processor configured to perform a method of any of the aspects 1 through 12.

Aspect 25: An apparatus for wireless communication at a UE, comprising at least one means for performing a method of any of aspects 1 through 12.

Aspect 26: A non-transitory computer-readable medium storing code for wireless communication at a UE, the code comprising instructions executable by a processor to perform a method of any of aspects 1 through 12.

Aspect 27: An apparatus for wireless communication at a network entity, comprising a memory and at least one processor coupled with the memory, the at least one processor configured to perform a method of any of the aspects 13 through 23.

Aspect 28: An apparatus for wireless communication at a network entity, comprising at least one means for performing a method of any of aspects 13 through 23.

Aspect 29: A non-transitory computer-readable medium storing code for wireless communication at a network entity, the code comprising instructions executable by a processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving an indication of a plurality of transmission-reception point (TRP) groups that comprise two or more TRPs, wherein the plurality of TRP groups are candidate TRP groups for communicating with the UE via joint transmission;
transmitting, for each TRP that is included in one or more of the plurality of TRP groups, an indication of one or more respective single-TRP precoding matrix components; and
transmitting, for each TRP group that is included in the plurality of TRP groups, an indication of one or more respective multi-TRP precoding matrix components, wherein a precoding matrix for a TRP group of the plurality of TRP groups is based at least in part on a combination of the one or more respective multi-TRP precoding matrix components for the TRP group and the one or more respective single-TRP precoding matrix components for each TRP included in the TRP group.

2. The method of claim 1, wherein transmitting the indication of the one or more respective single-TRP precoding matrix components comprises:
transmitting, for each TRP that is included in one or more of the plurality of TRP groups, an indication of one or more respective spatial domain basis matrices, one or more respective frequency domain basis matrices, or any combination thereof.

3. The method of claim 2, wherein transmitting the indication of the one or more respective multi-TRP precoding matrix components comprises:
transmitting, for each TRP group that is included in the plurality of TRP groups, an indication of one or more respective spatial-frequency coefficient matrices.

4. The method of claim 2, wherein transmitting the indication of the one or more respective single-TRP precoding matrix components further comprises:
transmitting, for each TRP that is included in one or more of the plurality of TRP groups, an indication of one or more respective spatial-frequency coefficient matrices.

5. The method of claim 4, wherein transmitting the indication of the one or more respective multi-TRP precoding matrix components comprises:
transmitting, for each TRP group that is included in the plurality of TRP groups, an indication of one or more respective scalar coefficients.

6. The method of claim 5, wherein each of the one or more respective scalar coefficients comprises a respective amplitude and a respective phase, the method further comprising:
receiving a control message indicating a first quantity of bits for encoding each of the respective amplitudes and a second quantity of bits for encoding each of the respective phases, wherein the indication of the one or more scalar coefficients is based at least in part on the encoding each of the respective amplitudes using the first quantity of bits and encoding each of the respective phases using the second quantity of bits.

7. The method of claim 1, wherein for each TRP that is included in one or more of the plurality of TRP groups, the one or more single-TRP precoding matrix components comprise at least one single-TRP precoding matrix component for each single-TRP spatial layer of each TRP.

8. The method of claim 1, wherein the plurality of TRP groups comprises a first TRP group, and wherein each TRP that is included in the first TRP group supports at least a respective first single-TRP spatial layer and a respective second single-TRP spatial layers, the method further comprising:
selecting a respective single-TRP spatial layer from each TRP that is included in the first TRP group, the selected single-TRP spatial layers corresponding to a first multi-TRP spatial layer of the first TRP group; and
determining the one or more respective multi-TRP precoding matrix components for the first TRP group based at least in part on the selected single-TRP spatial layers.

9. The method of claim 8, further comprising:
transmitting an indication of the selected single-TRP spatial layers corresponding to the first multi-TRP spatial layer of the first TRP group.

10. The method of claim 1, further comprising:
receiving a control message that indicates a procedure for reporting precoding matrix information, the indicated procedure included in a set of two or more candidate procedures for reporting the precoding matrix information that comprises a first procedure and a second procedure, wherein:
responsive to the first procedure being indicated, transmitting the indication of the one or more respective multi-TRP precoding matrix components for each TRP group included in the plurality of TRP groups comprises transmitting an indication of one or more respective spatial-frequency coefficient matrices for each TRP group included in the plurality of TRP groups; and
responsive to the second procedure being indicated, transmitting the indication of the one or more respective multi-TRP precoding matrix components for each TRP group included in the plurality of TRP groups comprises transmitting an indication of one or more respective scalar coefficients for each TRP group included in the plurality of TRP groups.

11. The method of claim 1, further comprising:
communicating with the TRP group via joint transmission based at least in part on the precoding matrix.

12. The method of claim 1, wherein:
the indication of the plurality of TRP groups is received as part of a channel state information reporting configuration message; and
the indications of the one or more respective single-TRP precoding matrix components and the indications of the one or more respective multi-TRP precoding matrix components are transmitted as part of a channel state information report.

13. A method for wireless communication at a network entity, comprising:
transmitting an indication of a plurality of transmission-reception point (TRP) groups that comprise two or more TRPs, wherein the plurality of TRP groups are candidate TRP groups for communicating with a user equipment (UE) via joint transmission;
receiving, for each TRP that is included in one or more of the plurality of TRP groups, an indication of one or more respective single-TRP precoding matrix components;
receiving, for each TRP group that is included in the plurality of TRP groups, an indication of one or more respective multi-TRP precoding matrix components; and
determining a precoding matrix for a TRP group of the plurality of TRP groups based at least in part on a combination of the one or more respective multi-TRP precoding matrix components for the TRP group and the one or more respective single-TRP precoding matrix components for each TRP included in the TRP group.

14. The method of claim 13, wherein receiving the indication of the one or more respective single-TRP precoding matrix components comprises:
receiving, for each TRP that is included in one or more of the plurality of TRP groups, an indication of one or more respective spatial domain basis matrices, one or more respective frequency domain basis matrices, or any combination thereof.

15. The method of claim 14, wherein receiving the indication of the one or more respective multi-TRP precoding matrix components comprises:
receiving, for each TRP group that is included in the plurality of TRP groups, an indication of one or more respective spatial-frequency coefficient matrices.

16. The method of claim 14, wherein receiving the indication of the one or more respective single-TRP precoding matrix components further comprises:
receiving, for each TRP that is included in one or more of the plurality of TRP groups, an indication of one or more respective spatial-frequency coefficient matrices.

17. The method of claim 16, wherein receiving the indication of the one or more respective multi-TRP precoding matrix components comprises:
receiving, for each TRP group that is included in the plurality of TRP groups, an indication of one or more respective scalar coefficients.

18. The method of claim 17, wherein each of the one or more respective scalar coefficients comprises a respective amplitude and a respective phase, the method further comprising:
transmitting a control message indicating a first quantity of bits for encoding each of the respective amplitudes and a second quantity of bits for encoding each of the respective phases, wherein the indication of the one or more scalar coefficients is based at least in part on the each of the respective amplitudes being encoded using the first quantity of bits and each of the respective phases being encoded using the second quantity of bits.

19. The method of claim 13, wherein for each TRP that is included in one or more of the plurality of TRP groups, the one or more single-TRP precoding matrix components comprise at least one single-TRP precoding matrix component for each single-TRP spatial layer of each TRP.

20. The method of claim 13, wherein the plurality of TRP groups comprises a first TRP group, and wherein each TRP that is included in the first TRP group supports at least a respective first single-TRP spatial layer and a respective second single-TRP spatial layers, the method further comprising:
receiving an indication of selected single-TRP spatial layers corresponding to a first multi-TRP spatial layer of the first TRP group, wherein:
the selected single-TRP spatial layers comprise a respective single-TRP spatial layer from each TRP that is included in the first TRP group; and
the one or more respective multi-TRP precoding matrix components for the first TRP group are based at least in part on the selected single-TRP spatial layers.

21. The method of claim 13, further comprising:
transmitting a control message that indicates a procedure for reporting precoding matrix information, the indicated procedure included in a set of two or more candidate procedures for reporting the precoding matrix information that comprises a first procedure and a second procedure, wherein:
responsive to the first procedure being indicated, receiving the indication of the one or more respective multi-TRP precoding matrix components for each TRP group included in the plurality of TRP groups comprises receiving an indication of one or more respective spatial-frequency coefficient matrices for each TRP group included in the plurality of TRP groups; and
responsive to the second procedure being indicated, receiving the indication of the one or more respective multi-TRP precoding matrix components for each TRP group included in the plurality of TRP groups comprises receiving an indication of one or more respective scalar coefficients for each TRP group included in the plurality of TRP groups.

22. The method of claim 13, further comprising:
communicating with the UE via the TRP group and joint transmission based at least in part on the precoding matrix.

23. The method of claim 13, wherein:
the indication of the plurality TRP groups is transmitted as part of a channel state information reporting configuration message; and
the indications of the one or more respective single-TRP precoding matrix components and the indications of the one or more respective multi-TRP precoding matrix components are received as part of a channel state information report.

24. An apparatus for wireless communication at a user equipment (UE), comprising:
memory;
a transceiver; and
at least one processor of the UE, the at least one processor coupled with the memory and the transceiver, and the at least one processor configured to:
receive, via the transceiver, an indication of a plurality of transmission-reception point (TRP) groups that comprise two or more TRPs, wherein the plurality of TRP groups are candidate TRP groups for communicating with the UE via joint transmission;
transmit, via the transceiver, for each TRP that is included in one or more of the plurality of TRP groups, an indication of one or more respective single-TRP precoding matrix components; and
transmit, via the transceiver, for each TRP group that is included in the plurality of TRP groups, an indication of one or more respective multi-TRP precoding matrix components, wherein a precoding matrix for a TRP group of the plurality of TRP groups is based at least in part on a combination of the one or more respective multi-TRP precoding matrix components for the TRP group and the one or more respective single-TRP precoding matrix components for each TRP included in the TRP group.

25. The apparatus of claim 24, wherein, to transmit the indication of the one or more respective single-TRP precoding matrix components, the at least one processor is configured to:
transmit, for each TRP that is included in one or more of the plurality of TRP groups, an indication of one or more respective spatial domain basis matrices, one or more respective frequency domain basis matrices, or any combination thereof.

26. The apparatus of claim 25, wherein, to transmit the indication of the one or more respective multi-TRP precoding matrix components, the at least one processor is configured to:
transmit, for each TRP group that is included in the plurality of TRP groups, an indication of one or more respective spatial-frequency coefficient matrices.

27. The apparatus of claim 25, wherein, to transmit the indication of the one or more respective single-TRP precoding matrix components, the at least one processor is configured to:
transmit, for each TRP that is included in one or more of the plurality of TRP groups, an indication of one or more respective spatial-frequency coefficient matrices.

28. An apparatus for wireless communication at a network entity, comprising:
memory; and
at least one processor of the network entity, the at least one processor coupled with the memory, and the at least one processor configured to:
transmit an indication of a plurality of transmission-reception point (TRP) groups that comprise two or more TRPs, wherein the plurality of TRP groups are candidate TRP groups for communicating with a user equipment (UE) via joint transmission;
receive, for each TRP that is included in one or more of the plurality of TRP groups, an indication of one or more respective single-TRP precoding matrix components;
receive, for each TRP group that is included in the plurality of TRP groups, an indication of one or more respective multi-TRP precoding matrix components; and
determine a precoding matrix for a TRP group of the plurality of TRP groups based at least in part on a combination of the one or more respective multi-TRP precoding matrix components for the TRP group and the one or more respective single-TRP precoding matrix components for each TRP included in the TRP group.

29. The apparatus of claim 28, wherein, to receive the indication of the one or more respective single-TRP precoding matrix components, the at least one processor is configured to:
receive, for each TRP that is included in one or more of the plurality of TRP groups, an indication of one or more respective spatial domain basis matrices, one or more respective frequency domain basis matrices, or any combination thereof.

30. The apparatus of claim 29, wherein, to receive the indication of the one or more respective multi-TRP precoding matrix components, the at least one processor is configured to:
receive, for each TRP group that is included in the plurality of TRP groups, an indication of one or more respective spatial-frequency coefficient matrices.
